(19) United States
(12) Patent Application Publication
(10) Pub. No.: US 2023/0411595 A1
(43) Pub. Date: Dec. 21, 2023

(54) RECHARGEABLE BATTERIES WITH ALKALI METAL ION CATHODES, ALUMINUM METAL-BASED ANODES AND DISPLACEMENT ELECTROLYTE

(71) Applicant: Sila Nanotechnologies, Inc., Alameda, CA (US)

(72) Inventors: Miguel CABAN-ACEVEDO, Alameda, CA (US); Gleb YUSHIN, Atlanta, GA (US)

(21) Appl. No.: 18/334,129

(22) Filed: Jun. 13, 2023

Related U.S. Application Data
(60) Provisional application No. 63/366,709, filed on Jun. 21, 2022.

(51) Int. Cl. H01M 4/134; H01M 10/0569; H01M 50/434; H01M 50/403; H01M 10/0587; H01M 4/1395

(52) U.S. Cl. CPC H01M 4/134; H01M 10/0569; H01M 50/434; H01M 50/403; H01M 10/0587; H01M 4/1395; H01M 2004/027

(57) ABSTRACT

In an aspect, a rechargeable battery cell, comprises an anode, a cathode, a separator layer electrically separating the anode and the cathode, and an electrolyte ionically coupling the anode and the cathode. In a further aspect, the anode comprises aluminum (Al) metal or an Al alloy, the cathode comprises a compound comprising an alkali metal, the electrolyte comprises Al and ions of the alkali metal, the Al in the electrolyte alloys with or plates on the anode and the ions of the alkali metal de-insert from the cathode into the electrolyte during charging of the rechargeable battery cell, and the Al de-alloy or de-plate from the anode into the electrolyte and the ions of the alkali metal in the electrolyte insert into the cathode during discharging of the rechargeable battery cell.

### BACKGROUND

### Field

The present disclosure relates generally to energy storage devices, and more particularly to metal and metal-ion battery technology and the like.

### Background

Owing in part to their relatively high energy densities, relatively high specific energy, relatively lightweight, and potential for long lifetimes, rechargeable metal batteries and rechargeable metal-ion batteries, such as lithium-ion (Li-ion), sodium-ion (Na-ion) or potassium-ion (K-ion) batteries, are desirable for a wide range of electric transportation, grid storage and other important applications. However, despite the increasing commercial prevalence of Li-ion batteries, further development of batteries is needed, particularly for potential applications in low- or zero-emission, hybrid-electrical or fully electrical transportation, energy-efficient cargo ships and locomotives, power grids and other energy storage systems for renewable energy-related applications.

One desired feature of metal and metal-ion batteries for some applications is enhanced safety. It is desirable that batteries do not induce fire, even under extreme cases such as a nail penetration test or other types of electrical shorting or over-heating or long-term storage or exposure to ultra-high current pulses. Solid electrolytes may, in principle, provide such enhanced safety. Unfortunately, the practical applications of solid-state batteries with solid electrolytes are often limited by lower energy density, lower power density, lower yield and higher material and processing costs. Another desired feature of metal and metal-ion batteries, especially for high-volume applications, is a reliance on broadly available and inexpensive raw materials within their anodes and cathodes, electrolyte, and current collectors. Unfortunately, state of the art metal and metal-ion batteries typically comprise metals that suffer from relatively high price and/or insufficient abundance in commercially viable reserves, such as nickel (Ni), cobalt (Co), and lithium (Li), to name a few. Many of such batteries also need phosphorus (P) in either the electrolyte or one of the electrodes (e.g., the cathode) or both. Yet another desired feature of metal and metal-ion batteries is a low self-discharge. Unfortunately, many rechargeable batteries suffer from undesirably fast self-discharge, especially at slightly elevated temperatures. Yet another desired feature of metal and metal-ion batteries is a broad temperature range of stable storage or operation. Unfortunately, many rechargeable batteries suffer from accelerated degradation upon exposure of such batteries to either too low (e.g., below 0° C.) or too high (e.g., above 50° C.) temperatures.

Accordingly, there remains a need for improved rechargeable batteries, components, and other related materials and manufacturing processes.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example battery in which the components, materials, methods, and other techniques described herein, or combinations thereof, may be applied according to various embodiments.

FIG. 2A-2B illustrates an example cross-section of the disclosed battery building block and possible electrochemical reactions which may be taking place on a cathode and an anode for an illustrative electrolyte composition.

FIGS. 3, 4 and 4B illustrate example processes for manufacturing cells in accordance with an embodiment of the disclosure.

FIG. 5 illustrates example processes for manufacturing energy storage system(s) with an embodiment of the disclosure.

FIG. 6A illustrates differential scanning calorimetry (DSC) measurements conducted on two example electrolyte compositions produced in accordance with an embodiment of the disclosure and showing low melting and solidification measurements.

FIG. 6B illustrates an example electrochemical impedance spectroscopy (EIS) plot on an illustrative electrolyte and the plots of ionic conductivities as a function of temperature extracted from EIS measurements on two illustrative electrolyte compositions.

FIG. 7 illustrates two example charge-discharge profiles of two example battery cells produced in accordance with an embodiment of the disclosure and comprising Al anode and two different cathodes—a layered metal oxide and an olivine metal phosphate.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a rechargeable battery cell includes an anode; a cathode; a separator layer electrically separating the anode and the cathode; and an electrolyte ionically coupling the anode and the cathode; wherein: the anode comprises aluminum (Al) metal or an Al alloy; the cathode comprises a cathode active material comprising at least one alkali metal; the electrolyte comprises Al and ions of the at least one alkali metal; the Al in the electrolyte alloys with or plates on the anode and the alkali metal de-insert from the cathode into the electrolyte during charging of the rechargeable battery cell; and the Al de-alloys or de-plates from the anode into the electrolyte and the alkali metal ions insert from the electrolyte into the cathode during discharging of the rechargeable battery cell.

In some aspects, the at least one alkali metal comprises sodium (Na) or potassium (K) or both.

In some aspects, the at least one alkali metal comprises the Na and an atomic fraction of the Na in all the alkali metal is about 50 at. % or more.

In some aspects, the at least one alkali metal comprises the K and an atomic fraction of the K in all the alkali metal is about 50 at. % or more.

In some aspects, a weight fraction of lithium (Li) in all the alkali metal is less than about 5 wt. %.

In some aspects, the electrolyte comprises a halide salt comprising Al, a nitrate salt comprising Al, and/or an imide salt comprising an alkali metal.

In some aspects, the electrolyte exhibits a melting point in a range of about 40° C. to about 300° C.

In some aspects, the melting point is in a range of about 60° C. to about 220° C.

In some aspects, the electrolyte comprises an ionic liquid.

In some aspects, the electrolyte comprises a solvent composition, a boiling point of the solvent composition being at least about 120° C.

In some aspects, the electrolyte comprises a solvent composition, a weight fraction of the solvent composition in the electrolyte being about 10 wt. % or less.

In some aspects, the electrolyte is fully or partially solid during at least a portion of the charging and/or discharging of the rechargeable battery cell.

In some aspects, the separator membrane comprises elongated particles with an average aspect ratio of about 30 or greater.

In some aspects, the separator membrane comprises ceramic particles.

In some aspects, the cathode active material comprises a layered metal oxide or an olivine metal phosphate or Prussian Blue/Prussian White analogs.

In some aspects, a concentration of the Al in the electrolyte increases during the discharging; a concentration of the alkali metal ions in the electrolyte decreases during the discharging; the concentration of the Al in the electrolyte decreases during the charging; and the concentration of the alkali metal ions in the electrolyte increases during the charging.

In an aspect, an energy storage system includes a plurality of instantiations of the rechargeable battery cell.

In an aspect, a method of making a rechargeable battery cell includes (A1) providing an anode comprising aluminum (Al) metal or an Al alloy; (A2) providing a cathode comprising a cathode active material comprising at least one alkali metal; (A3) melt-infiltrating an electrolyte into (a) the anode, or (b) the cathode, or (c) the anode and the cathode; and (A4) assembling the rechargeable battery cell comprising the anode and the cathode, wherein: the electrolyte ionically couples the anode and the cathode in the rechargeable battery cell; and the electrolyte comprises Al and ions of the at least one alkali metal.

In some aspects, the electrolyte exhibits a melting point in a range of about 40° C. to about 300° C.

In some aspects, the method further comprises providing a separator layer on at least one of the anode and the cathode.

In an aspect, a rechargeable battery cell includes an anode; a cathode; a separator layer electrically separating the anode and the cathode; and an electrolyte ionically coupling the anode and the cathode; wherein: the anode comprises aluminum (Al) metal or an Al alloy; the cathode comprises a compound comprising an alkali metal; the electrolyte comprises Al and ions of the alkali metal; the Al in the electrolyte alloys with or plates on the anode and the ions of the alkali metal de-insert from the cathode into the electrolyte during charging of the rechargeable battery cell; and the Al de-alloy or de-plate from the anode into the electrolyte and the ions of the alkali metal in the electrolyte insert into the cathode during discharging of the rechargeable battery cell.

In some aspects, the cathode comprises Na or K or both.

In some aspects, the electrolyte is fully or partially solid during at least a portion of the charging and/or discharging of the rechargeable battery cell.

Other objects and advantages associated with the aspects disclosed herein will be apparent to those skilled in the art based on the accompanying drawings and detailed description.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aspects of the present disclosure provide for processes of making advanced carbon-containing composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “˜” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| | | Measurement | |
|---|---|---|---|
| Material Type | Property Type | Instrumentation | Measurement Technique |
| Active | Coulombic | Potentiostat | Charge (current) is passed to an |
| Material | Efficiency | | electrode containing the active |
| | | | material of interest until a given |
| | | | voltage limit is reached. Then, |
| | | | the current is reversed until a |
| | | | second voltage limit is reached. |
| | | | The ratio of the charge passed |
| | | | determines the coulombic |
| | | | efficiency. |
| Active | Partial Vapor | Manometer | The partial vapor pressure of an |
| Material | Pressure (e.g., | | active material in a mixture |
| | Torr.) at a | | (e.g., composite particle) at a |
| | Temperature | | particular temperature is given |
| | (e.g., K) | | by the known vapor pressure of |
| | | | the active material multiplied by |
| | | | its mole fraction in the mixture. |
| Active | Volume | Gas pycnometer | Gas pycnometer measures the |
| Material | | | skeletal volume of a material by |
| | | | gas displacement using the |
| | | | volume-pressure relationship of |
| | | | Boyle's Law. A sample of |
| | | | known mass is placed into the |
| | | | sample chamber and maintained |
| | | | at a constant temperature. An |
| | | | inert gas, typically helium, is |
| | | | used as the displacement |
| | | | medium. |
| Particle | | | Note: A vol. % change may be |
| | | | calculated from two volume |
| | | | measurements of the active |
| | | | material particle. |
| Active | Open Internal | nitrogen | nitrogen sorption/desorption |
| Material | Pore Volume | sorption/desorption | isotherm technique |
| Particle | (e.g., cc/g or | isotherm | |
| | cm³/g) | | |
| Active | Volume- | PSA, scanning | PSA using laser scattering, |
| Material | Average Pore | electron microscope | electron microscopy (SEM, |
| Particle | Size (e.g., nm) | (SEM), transmission | TEM, STEM), laser microscopy |
| | | electron microscope | (for larger particles), optical |
| | | (TEM), scanning | microscopy (for larger |
| | | transmission | particles), neutron scattering, X- |
| | | microscope (STEM), | ray microscopy imaging |
| | | laser microscope, | |
| | | Synchrotron X-ray, | |
| | | X-ray microscope | |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing to the theoretical |
| | | | density of the individual |
| | | | material components present in |
| | | | Si-comprising particles |
| Active | Closed | Gas pycnometer | With a pycnometer, the amount |
| Material | Internal | | of a certain medium (liquid or |
| Particle | Volume- | | Helium or other analytical |
| | Average Size | | gases) displaced by a solid can |
| | (e.g., nm) | | be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), X- |
| | | | ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in |
| | %, mg, | | the particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known theoretical capacit(ies) |
| | | | of each active material. |
| | | | Note #3: The composition of the |
| | | | particle may be characterized in |
| | | | terms of weight (e.g., mg). The |
| | | | composition of may |
| | | | alternatively be characterized by |
| | | | a number of atoms of a |
| | | | particular element (e.g., Si, C, |
| | | | etc.). In case of atoms, the |
| | | | number of atoms may be |
| | | | estimated from the weight of |
| | | | that atom in the particle (e.g., |
| | | | based on gas chromatography) |
| Active | Specific | Potentiostat | An electrode containing an |
| Material | Capacity | | active anode or cathode material |
| Particle, | | | of interest is charged or |
| Battery Half- | | | discharged (by passing electrical |
| Cell | | | current to the electrode) within |
| | | | certain potential limits using an |
| | | | electrochemical cell with |
| | | | suitable reference electrode, |
| | | | typically lithium metal. The |
| | | | total charge passed divided by |
| | | | the active material mass gives |
| | | | this quantity. The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a sealed |
| Material | (e.g., m²/g) | | chamber, where nitrogen is |
| Particle | | | introduced. The change in |
| | | | pressure of the nitrogen is used |
| | | | to calculate the surface area of |
| | | | the sample. |
| Active | Aspect Ratio | SEM, TEM | The dimensions and shape of |
| Material | | | the particles are measured in |
| Particle | | | SEM or TEM. |
| Active | True Density | Argon Gas | True density values may be |
| Material | of Particle | Pycnometer | measured by using an argon gas |
| Particle | (e.g., g/cc or | | pycnometer and comparing to |
| | g/cm³) | | the theoretical density of the |
| | | | individual material components |
| | | | present in the particle. |
| Active | Particle Size | Dynamic light | laser particle size distribution |
| Material | Distribution | scattering particle | analysis (LPSA) on well- |
| Particle | (e.g., nm or | size analyzer, | dispersed particle suspensions in |
| Population | μm) | scanning electron | one example or by image |
| | | microscope | analysis of electron microscopy |
| | | | images, or by other suitable |
| | | | techniques. While there are |
| | | | diverse processes of measuring |
| | | | PSDs, laser particle size |
| | | | distribution analysis (LPSA) is |
| | | | quite efficient for some |
| | | | applications. Note that other |
| | | | types of particle size |
| | | | distribution (e.g., by SEM |
| | | | image analysis) could also be |
| | | | utilized (and may even lead to |
| | | | more precise measurements, in |
| | | | some experiments). Using |
| | | | LPSA, particle size parameters |
| | | | of a population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a ninetieth- |
| | | | percentile volume-weighted |
| | | | particle size parameter (e.g., |
| | | | abbreviated as D₉₀), and a |
| | | | ninety-ninth-percentile volume- |
| | | | weighted particle size parameter |
| | | | (e.g., abbreviated as D₉₉). |
| Active | Width (e.g., | PSA | Parameters relating to |
| Material | nm) | | characteristic widths of the PSD |
| Particle | | | may be derived from these |
| Population | | | particle size parameters, such as |
| | | | D₅₀ − D₁₀ (sometimes referred to |
| | | | herein as a left width), D₉₀ − D₅₀ |
| | | | (sometimes referred to herein as |
| | | | a right width), and D₉₀ − D₁₀ |
| | | | (sometimes referred to herein as |
| | | | a full width). |
| Active | Cumulative | Computed via LPSA | A cumulative volume fraction, |
| Material | Volume | data | defined as a cumulative volume |
| Particle | Fraction | | of the composite particles with |
| Population | | | particle sizes of a threshold |
| | | | particle size or less, divided by a |
| | | | total volume of all of the |
| | | | composite particles, may be |
| | | | estimated by LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m2/g) | | nitrogen sorption-desorption at |
| Particle | | | cryogenic temperatures, such as |
| Population | | | about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar mass of the |
| | | | salt is then used to calculate the |
| | | | total number of moles of salt in |
| | | | the solution. The moles of salt is |
| | | | then divided by the total volume |
| | | | to obtain the solvent |
| | | | concentration in M (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar volume of |
| | | | each solvent is then used to |
| | | | calculate the total number of |
| | | | moles of solvent in the solution. |
| | | | The moles of solvent is then |
| | | | divided by the total volume to |
| | | | obtain the solvent concentration |
| | | | in M (mol/L). |
| Electrode | Composition | Balance | The mass fraction of a material |
| | (e.g., mass | | (e.g., active material, active |
| | fraction or wt. | | material particle, binder, etc.) in |
| | %) | | the electrode is calculated based |
| | | | on a measured or estimated |
| | | | mass of the material and a |
| | | | measured or estimated mass of |
| | | | the electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of the |
| | | | battery electrode composition |
| | | | may be measured before being |
| | | | mixed into a slurry to estimate |
| | | | their mass in a casted electrode. |
| | | | The mass of materials deposited |
| | | | onto the casted electrode may be |
| | | | measured by comparing the |
| | | | weight of the casted electrode |
| | | | before/after the material |
| | | | deposition. |
| Electrode | Areal Binder | balance | A mass fraction of the binder in |
| | Loading (e.g., | | the battery electrode, divided by |
| | mg/m²) | | a product of (1) a mass fraction |
| | | | of the active material (e.g., Si—C |
| | | | nanocomposite, etc.) particles in |
| | | | the battery electrode, and (2) a |
| | | | Brunauer-Emmett-Teller (BET) |
| | | | specific surface area of the |
| | | | population |
| Electrode | Capacity | Calculated | Measure mass (wt.) of active |
| | Attributable to | | material in electrode, and |
| | Active | | calculate electrode capacity |
| | Material | | based on known theoretical |
| | (active | | capacity of the active material. |
| | material | | For example, the average wt. % |
| | capacity | | of active material in each active |
| | fraction) | | material particle may be |
| | | | measured, and used to calculate |
| | | | the mass of the active material |
| | | | based on the mass of the active |
| | | | material particles before being |
| | | | mixed in slurry. This process |
| | | | may be repeated if the electrode |
| | | | includes two or more active |
| | | | materials to calculate the |
| | | | relative capacity attribution for |
| | | | each active material in the |
| | | | electrode. |
| Electrode | Capacity | Potentiostat and | Determine average specific |
| | Attributable to | balance | capacity (g/mAh) of active |
| | Active | | material particles. For example, |
| | Material | | the average specific capacity |
| | Particles | | may be estimated from the |
| | (active | | average wt. % of active |
| | material | | material(s) in each particle and |
| | particle | | its associated known theoretical |
| | capacity | | capacit(ies). Then, measure |
| | fraction) | | mass (wt.) of active material |
| | | | particles in electrode before |
| | | | being mixed in slurry, which |
| | | | may be used to calculate the |
| | | | capacity attributable to that |
| | | | active material. This process |
| | | | may be repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active material |
| | Material in | | particle may be measured, and |
| | Electrode | | used to calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in slurry. |
| | Electrode | | |
| Electrode | Areal | Potentiostat and | Areal capacity loading is weight |
| | Capacity | balance | of the coated active material per |
| | Loading (e.g., | | unit area (g/cm²) multiplied by |
| | mAh/cm²) | | the gravimetric capacity of the |
| | | | active material (not the |
| | | | electrode, but the active material |
| | | | itself with zero binder and zero |
| | | | electrolyte; mAh/g). |
| Electrode | Coulombic | Potentiostat | The change in charge inserted (or |
| | Efficiency | | extracted) to an electrode |
| | | | divided by the charge extracted |
| | | | (or inserted) from the electrode |
| | | | during a complete |
| | | | electrochemical cycle within |
| | | | given voltage limits. Because the |
| | | | direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half- |
| | | | cell, which is an electrochemical |
| | | | cell consisting of a cathode or |
| | | | anode material of interest as the |
| | | | working electrode and a lithium |
| | | | metal foil which functions as |
| | | | both the counter and reference |
| | | | electrode. Then, charge is either |
| | | | inserted or removed from the |
| | | | material of interest until the cell |
| | | | voltage reaches an appropriate |
| | | | limit. Then, the process is |
| | | | reversed until a second voltage |
| | | | limit is reached, and the charge |
| | | | passed in both steps is used to |
| | | | calculate the Coulombic |
| | | | Efficiency, as described above. |
| Battery Cell | Rate | Potentiostat | This is the time it takes to |
| | Performance | | charge or discharge a battery |
| | | | between a given state of charge. |
| | | | It is measured by charging or |
| | | | discharging a battery and |
| | | | measuring the time until a |
| | | | specified amount of charge is |
| | | | passed, or until the battery |
| | | | operating voltage reaches a |
| | | | specified value. |
| Battery Cell | Cell | Potentiostat | A battery consisting of a |
| | Discharge | | relevant anode and cathode is |
| | Voltage (e.g., | | charged and discharged within |
| | V) | | certain voltage limits and the |
| | | | charge-weighted cell voltage |
| | | | during discharge is computed. |
| Battery Cell | Operating | Potentiostat and | Average temperature of battery |
| | Temperature | thermocouples | cell as measured at the |
| | | | positive/negative terminal/cell |
| | | | shaft/etc. while |
| | | | charging/discharging, or at a |
| | | | certain voltage level, or while a |
| | | | load is applied, etc. |
| Battery Half- | Anode | Potentiostat | An electrode containing an |
| Cell | Discharge (de- | | active anode material (or |
| | lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or |
| | (lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | the VED is calculated by first |
| | Energy | | calculating the energy per unit |
| | Density | | area of the battery, and then |
| | (VED) | | dividing the energy per unit area |
| | | | by the sum of the illustrative |
| | | | anode, cathode, separator, and |
| | | | current collector thicknesses |
| Battery Cell | Internal | Potentiostat | The internal resistance (also |
| | Resistance | | known as impedance in many |
| | (impedance) | | contexts) is measured by |
| | | | applying small pulses of current |
| | | | to the battery cell and recording |
| | | | the instantaneous change in cell |
| | | | voltage. |
| Any Liquid | Surface | Surface Tensiometer | Surface Tension in mN/m may |
| | Tension | (e.g., Bubble | be measured at room |
| | | Pressure | temperature |
| | | Tensiometer) | |
| Any Liquid | Viscosity (cP) | Viscometer (e.g., | Viscosity of a liquid may be |
| | | Brookfield | measured at room temperature |
| | | Viscometer) | |

In some embodiments described below, certain parameters (e.g., temperature, state-of-charge (SOC), etc.) may be defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

Aspects of the present invention particularly benefit relatively large battery cells, such as cells with the energy more than about 1 Wh (in some designs, from about 1 Wh to about 20 Wh; in other designs, from about 20 Wh to about 100 Wh; in other designs, from about 100 Wh to about 250 Wh; in yet other designs, from about 250 Wh to about 500 Wh; in yet other designs, from about 500 Wh to about 2 kWh). This is because relatively large cells may become particularly sensitive to self-heating induced by large internal resistance, particularly if electrodes with relatively large areal capacity loadings are utilized. Some aspects of this disclosure describe means to reduce electrode resistance by utilizing suitable solvent-free electrode fabrication techniques.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated intercalation-type cathode materials, partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal oxyfluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various mixtures, composites (including nanocomposites) and alloys and others.

While the description below may describe certain cathode examples in the context of single alkali ion battery cathodes (such as sodium (Na)-ion battery cathodes or potassium (K)-ion battery cathodes) (for brevity and convenience), it will be appreciated that various aspects may be applicable to cathodes that comprise and/or reversible store 2, 3 or more different alkali ions (such as Na⁺ and K⁺ ions or Na⁺ and lithium (Li)⁺ or K⁺ and Li⁺ or Na⁺, K⁺ and Li⁺, etc.).

While the description below may describe certain electrolyte examples that comprise aluminum (Al) and a single alkali metal element (such as Na) (for brevity and convenience), it will be appreciated that various aspects may be applicable to electrolytes that comprise Al and 2, 3 or more different alkali metal elements (such as Na and K or K and Li or Na and Li or K, Na and Li, etc.).

While the description below may describe certain electrolyte examples that comprise only Al and alkali metals, it will be appreciated that various aspects may be applicable to electrolytes that comprise other metals and semimetals (such as other metals and semimetals in addition to Al and alkali metals, in some examples). For example, in some designs, various aspects may be applicable to electrolytes that comprise Zn or Mg.

While the description below may describe certain electrolyte examples that comprise only inorganic anions, it will be appreciated various aspects may be applicable to electrolytes that comprise organic anions (in some designs, as a mixture of inorganic and organic anions).

While the description below may describe certain electrolyte examples that comprise only inorganic cations (such as Na⁺, K⁺, Li⁺, Al³⁺, among others), it will be appreciated that various aspects may be applicable to electrolytes that additionally comprise organic cations.

While the description below may describe certain electrolyte examples that comprise a single halogen (e.g., chlorine (Cl)), it will be appreciated various aspects may be applicable to electrolytes that comprise 2 or more halogens (e.g., Cl and Br or Cl and F and Br or Cl and I, etc.).

While the description below may describe certain electrolyte examples that comprise a mixture of simple salts (e.g., salts that may be formed via neutralization reaction between acids and bases), it will be appreciated some electrolyte compositions may comprise double salts (e.g., salts that comprise more than one anion or cation per molecule) or complex salts (e.g., combination of molecular compounds and ions, which means they both have charged ions and neutral molecules; a central ion is often surrounded by the ions and neutral molecules, thereby forming a complex). Also note that the individual salt components in the electrolyte examples may comprise acidic, basic, and neutral salts.

While the description below may describe certain electrolyte examples that only comprise salts, it will be appreciated that some electrolyte compositions may comprise some amounts of an organic or an inorganic solvent or an ionic liquid or a monomer or a polymer or their various combinations.

While the description below may describe certain electrolyte examples that reversibly change their bulk composition during charge and discharge of a battery cell, it will be appreciated that various aspects may be applicable to electrolytes that undergo irreversible changes in bulk composition during the initial (often called “formation”) cycling. In some designs, such a compositional change may be accompanied by the irreversible plating (electro-deposition) of one or more metals or semi-metals (e.g., in the form of a metal or a metal alloy deposits) on an anode current collector during charge. In some designs, such a plated semimetal, metal or metal alloy may comprise one, two, three, four or more of the following elements (with at least about 0.01 wt. % in the alloy composition): Al, Zn, Mg, Zr, Ti, Ta, Be, Sc, Na, Li, Bi, Mn, Cr, W, Mo, Fe, Cd, Co, Ni, Sb, Sn, Si, B, Cu, Ag, V, Pb, Nb, Ga, La, Y and Ce, to name a few examples as this list is not meant to be comprehensive. In some designs, such a deposition process may enhance cell stability or rate performance of the disclosed battery cells.

While the description below may describe certain battery anode examples that comprise a pure Al metal anode composition, it will be appreciated that various aspects may be applicable to anodes that comprise Al metal alloys. In some designs, semimetal, metal or metal alloy may comprise about 30-99 wt. % of Al (in some designs, about 50-98 wt. % of Al). In some designs, other metals in such alloys (with at least about 0.01 wt. % in the alloy composition) may comprise one, two, three, four or more of the following elements: Zn, Mg, Zr, Ti, Ta, Be, B, Sc, Na, Li, Bi, Mn, Cr, W, Mo, Fe, Cd, Co, Ni, Sb, Sn, Si, Cu, Ag, V, Ga, Pb, Nb, La, Y and Ce, to provide a few illustrative examples, although this list is not meant to be comprehensive. In some designs, it may be advantageous for the metal or metal alloys to exhibit average grain size in the range from about 0.5 nm to about 500 nm (e.g., about 0.5-2 nm or about 2-10 nm or about 10-50 nm or about 50-200 nm or about 200-500 nm).

While the description below may describe certain examples of the solid electrolytes in the context of cation-based (such as metal-ion, including Na-ion or K-ion or Li-ion cation-based) electrolytes where cations (such as Na⁺ cations, K⁺ cations and others) contribute to the vast majority (e.g., up to about 55-100%) of the total electrolyte ionic conductivity, it will be appreciated that various aspects may be applicable to solid electrolytes that either primarily (e.g., by about 55-100%) rely on anion conduction (such as Cl⁻ or AlCl₄⁻ or Al₂Cl₇⁻ or other anion conduction) or exhibit mixed cationic and anionic conductivities, where each type of ions contribute to more than about 5% and less than about 95% of the total ionic conductivity.

While the description below may describe certain examples in the context of single phase (including a solid solution) electrolyte compositions, it will be appreciated that various aspects may be applicable to composition comprising two or three or even four distinct phases. Each phase may exhibit a different melting point, mechanical properties, microstructure, density, chemical composition and/or ionic conductivity.

While the description below may describe certain examples in the context of one type or composition of the electrolyte in cells, it will be appreciated that various aspects may be applicable to cells comprising two or three or more electrolyte compositions. Each electrolyte composition may exhibit a different melting point, mechanical properties, microstructure, density, chemical composition and/or ionic conductivity. In some designs, an anode may be in direct contact with a different electrolyte composition or different electrolyte mixture than a cathode.

While the description below may describe certain examples of cathode materials in the context of certain types of intercalation-type cathode chemistries, it will be appreciated that various aspects may be applicable to various other types of intercalation-type cathode chemistries as well as conversion-type cathode chemistries (including displacement type) and mixed intercalation/conversion-type cathode chemistries.

While the description below may describe certain cathode examples (for use in combination with suitable solid electrolytes) in the context of Na⁺, K⁺ and/or Li⁺ storage in the cathodes based on the transition metal (such as Cu, Fe, Mn, Ni, Bi, Co, etc.) reduction-oxidation (redox) reactions, it will be appreciated that various aspects may be applicable to materials where a portion of Li storage relies on the anion (such as oxygen, O, etc.) redox reactions in the cathodes, where at least one electronegative element in the anion may exhibit multiple oxidation states.

While the description below may describe certain cathode examples (for use in combination with suitable solid electrolytes) in the context of “pure” conversion-type chemistry or “pure” intercalation-type chemistry of active cathode materials, it will be appreciated that various aspects may be applicable to mixed intercalation/conversion type active materials where both intercalation and conversion mechanisms of ion storage may take place during battery cell operation. Furthermore, in some designs, primarily (e.g., about 50-100%) intercalation-type mechanism(s) of (e.g., K⁺ or Na⁺ or Li⁺) ion storage may take place during some range of the cell charge or discharge (as an illustrative but not limited example, from around 0.0% to around 40.0% of the full discharge capacity). Similarly, in some designs, primarily (e.g., about 50-100%) conversion-type mechanism(s) of (e.g., K⁺ or Na⁺ or Li⁺) ion storage may take place during some range of the cell charge or discharge (as an illustrative but not limited example, from around 0.5% to around 100.0% of the full discharge capacity). For cathodes that comprise more than one alkali metal ion, these ranges may vary.

While the description below may describe certain cathode examples (for use in combination with suitable solid electrolytes) in the context of a single cathode active material composition (e.g., a particular metal phosphate or metal oxide or Prussian Blue/Prussian White analogs or metal fluoride or metal oxyfluoride or metal sulfide, etc.), it will be appreciated that cathode may comprise two, three or more distinctly different particles having different composition, different ion insertion/extraction potentials, different rate performance, different size, different morphology, different surface chemistry or surface coatings and other different physical, chemical or electrochemical properties.

While the description below may describe certain examples in the context of particular electrode or electrode particle chemistry, composition, architecture and morphology, certain examples in the context of particular or electrode particle synthesis steps, certain examples in the context of particular electrolyte composition, certain examples in the context of particular electrolyte incorporation into an electrode or a battery cell, certain examples in the context of particular separator chemistry, composition, architecture, morphology, certain examples in the context of particular or electrode separator fabrication or integration steps, it will be appreciated that various aspects may be applicable to battery cells that advantageously incorporate various combinations of some of the described electrode chemistries, composition, architecture, electrolyte composition and integration, separator composition and integration, electrode or cell manufacturing techniques.

While the description below may describe certain examples of separators in the context of a particular thermally-stable porous separator chemistry (such as various metal and semimetal (e.g., Al, Mg, Si, and their various combinations, etc.) oxides, hydroxides and oxyhydroxides such as, for example, Al₂O₃, AlO(OH), Al(OH)₃, NaAlO₂, NaAl₅O₈, MgO, MgSiO₃, Mg(OH)₂, SiO₂, Al₂SiO₅, Al₂Si₂O₇, A₁₄SiO₈, A₁₆Si₂O₁₃, Al₂Mg₂Si₅O₁₅, etc.) or morphology (e.g., fibers, nanofibers, nanowires, nanoflakes, nanoplatelets, platelets, etc.; nonwoven, etc.) for use in combination with the disclosed electrolyte compositions, it will be appreciated that various aspects may be applicable to other types or chemistries or morphologies of thermally stable separators and also to the lack of standalone separators.

While the description below may describe certain examples of the electrolyte composition and properties for melt-infiltration into a separator or a cathode or an anode or their various combinations (including melt-infiltration into a battery stack or roll, etc.), it will be appreciated that various aspects may be applicable to the electrolytes of the described compositions or properties that are incorporated into cells by other (not melt-infiltration) techniques (e.g., as standalone or electrode-coated membranes, as current collector-deposited/coated layer, by solution infiltration, by slurry casting, by sputtering, by spraying, by electrodeposition, by electroless deposition, by layer-by-layer deposition, by various vapor deposition techniques (such as chemical vapor deposition CVD, physical vapor deposition PVD, atomic layer deposition ALD, etc.), among others).

While the description below may describe certain examples in the context of melt-infiltration electrolyte filling methodologies for cell fabrication, it will be appreciated that various aspects may be applicable to other methodologies of electrolyte filling (or, more generally, electrolyte incorporation) for cell fabrication.

While the description below may describe certain examples of electrolyte composition(s) that may be used to attain certain suitable electrolyte properties for effective cell design, it will be appreciated that in some designs other electrolyte compositions may be selected to achieve suitable electrolyte properties for cell design and manufacturing.

While the description below may describe certain examples of comprising a single electrolyte, it will be appreciated that two or more distinct electrolyte compositions may be used within an individual cell.

While the description below may describe certain examples of cells comprising only a solid (e.g., at room temperature) electrolyte, it will be appreciated that various aspects may be applicable to cells comprising both solid and liquid electrolyte(s) (e.g., at room temperature).

While the description below may describe certain examples of cells comprising only inorganic solid (at room temperature) electrolyte, it will be appreciated that various aspects may be applicable to cells comprising organic (e.g., solid polymer or polymer gel or other types of organic) or mixed (organic-inorganic) electrolyte(s).

While the description below may describe certain examples of cells (e.g., Li or Li-ion cells) that comprise electrolyte that is solid at room temperature and is solid at operating temperatures, it will be appreciated that various aspects may be applicable to cells comprising electrolyte that is solid at room temperature, but may become viscous glass or liquid at least at some operating temperatures.

There is a strong desire to reduce reliance on Li, Co, Ni, and other metals that have rather limited availability in Earth's crust in the rechargeable battery construction, and to focus on the use of broadly available and easily accessible metals and semimetals, particularly for grid storage and transportation applications. There is also a strong desire to improve battery safety and minimize the use of flammable electrolytes.

Rechargeable Na-ion and K-ion batteries could be constructed with hard carbon-based anodes and cathodes that are largely free from Li, Co and Ni (and, for example, rely on the use of carbon (C), nitrogen (N), iron (Fe), manganese (Mn) and other broadly available elements). However, these battery cells commonly suffer from low energy density and specific energy, high flammability of organic electrolytes used, relatively low rate and insufficiently good cycle life performance at operational temperatures, among other limitations. Increasing the operation temperature may enhance rate performance, but at the expense of reduced cycle life, poor calendar life and, even worse, safety. Hard carbon not only offers smaller volumetric capacity compared with graphite anode used in rechargeable Li-ion batteries, but also often suffers from high first cycle losses. In addition, hard carbon anodes are relatively expensive to produce. Replacing hard carbon anodes with high-capacity metal anodes may enhance specific energy and energy density of batteries. For example, rechargeable Na-metal and K-metal batteries offer higher energy density and specific energy than Na-ion and K-ion batteries built with the same cathodes, but suffer from even more severe safety concerns and cycle life limitations. Indeed, Na metal and K metal are very challenging to fully reversibly electrodeposit and dissolve during charge and discharge (e.g., such metals tend to gradually pulverize and form isolated regions and dendrites instead of uniform and smooth electrodeposition and electro-dissolution) and are also highly flammable upon contact with moisture or air. Both low and high temperature performance of such cells are typically poor too. The use of solid electrolyte membranes (e.g., based on sulfides and oxides) in Na and K metal batteries may reduce some of the safety concerns, but may bring about additional challenges with cell construction and still offer limited stability, relatively low rate, and overall performance. Conventional solid electrolytes and solid state Na metal, Na-ion, K metal, and K-ion cells (batteries) typically suffer from various limitations, such as (i) low ionic conductivity (and thus low rate performance of solid cells); (ii) low practically-achievable energy density (e.g., due to the typically used milling procedure for the fabrication of electrodes with solid electrolytes, which requires excessive content of conductive additives and electrolyte for achieving reasonable rate performance and high capacity utilization); (iii) large thickness (e.g., typically above 50 microns) of the solid electrolyte (separator) membranes (e.g., due to the typical formation of such solid membranes by sintering solid electrolyte powders), which increases the volume occupied by the inactive material, thus increasing cell cost and reducing cell energy density; (iv) the brittle nature of the ceramic solid electrolytes and solid-state batteries, which limits their applications and life; (v) the lack of flexibility in typical solid-state batteries with solid ceramic electrolytes, which limits their applications and life; (vi) typically rather high interface resistance between the solid electrolyte and the electrode materials (e.g., anode or cathode, or both), which limits their rate performance and temperature of efficient operation; (vii) often high reactivity of some of the solid electrolytes with many typically used electrode materials and current collectors (particularly for sulfide-comprising electrolytes), which may induce corrosion and other undesirable reactions during heating of the cell during fabrication or even during use at elevated temperatures (e.g., typically above around 40° C.); (viii) often high reactivity of many solid electrolytes with air and moisture, which often requires electrodes comprising solid state electrolyte to be produced in dry-rooms or gloveboxes (which may be prohibitively expensive for many applications and may not be practical); (ix) penetration of solid electrolytes by metal dendrites (e.g., Na or K dendrites in the case of Na or K metal batteries, respectively) during cycling, which may induce self-discharge, battery failure and safety hazards; (x) cracks and defects forming at the interface between the solid electrolyte and electrode materials (e.g., due to substantial volume changes (e.g., above 2%) in many electrode materials during cycling, which most solid electrolytes fail to accommodate) leading to capacity fading, resistance growing, and failures; (xi) various mechanical and electrochemical instabilities due to difficulty of the solid electrolytes to accommodate volume or shape changes in the electrode materials during cycling or electrochemical or chemical instabilities of the solid electrolyte in contact with metal anodes (e.g., Na or K metal anodes), particularly in case of metal anode plating; (xii) in some cases high toxicity of the products of the reaction of the solid electrolyte with moisture (e.g., during cell stack assembling or handling the solid electrolyte membranes in air); among others. In addition, conventional solid-state Na, K, Na-ion or K-ion batteries cannot typically be used with conversion-type active electrode materials, due to the undesirable interactions with such materials and due to the dramatic volume changes in such active materials, which cannot be accommodated by solid electrolytes in typical cells. In addition, conventional solid-state electrolytes (SSEs) are often incorporated into cells as stand-alone membranes, which are extremely expensive to produce with sufficiently (for most applications) low areal density/concentration of defects (e.g., small cracks, small holes or pores, grain boundaries, excessive roughness on the surface, among others), which may lead to low cell fabrication yield and low cycle life. Finally, many conventional designs of the solid-state Na or K batteries require the use of liquid electrolyte in the cathode. Such designs often suffer from liquid electrolyte flammability, relatively low oxidation stability of the liquid electrolyte (particularly at high voltages), often undesired reactivity with the cathode material, often gassing, often leakage and/or other limitations.

Rechargeable Al-ion batteries suffer from severe rate limitations on both the anode and cathode sides due to large ion charge (+3) and large barrier for solid state diffusion. Rechargeable Al metal batteries may benefit from using a safe and ultra-high volumetric capacity Al metal anode (its volumetric capacity is over 7 times higher than Na metal anode and over 13 times higher than K metal anode), but suffer from the lack of safe, stable, low-cost, high-rate, and reasonably high-capacity cathode. In addition, many electrolytes used in Al metal ion batteries bring other issues (e.g., safety, complexity to use, difficult integration, low conductivity, poor performance at elevated temperatures, etc.).

Dual-ion batteries typically rely on both the cations and anions for cell operation (insertion into electrodes), where, for example, smaller cations are inserted into an anode (e.g., hard carbon or porous carbon) or plated to form a metal anode (e.g., Na metal anode or K metal or Al metal anode) during charge, while larger anions are inserted into a cathode (e.g., hard carbon or graphite or porous carbon, etc.) during charge. During discharge, both anions and cations return back into the electrolyte. Unfortunately, dual-ion batteries also typically offer limited cycle life, poor rate performance (since inserted (e.g., intercalated) anions are typically much larger in size and suffer from slow diffusion) and poor safety, and most importantly require excessive amount of electrolyte since it is consumed during charge (ions are typically stored in the electrolyte itself, and it typically suffers from low volumetric and gravimetric capacities due to the presence of significant amounts of solvents) and released during discharge, thereby causing significant variation in cell volume and limiting energy density and other characteristics of dual-ion battery cells.

Aspects of the disclosure are directed to novel cell compositions, designs and constructions focused on overcoming the known limitations of battery cells that do not rely on Li (or use reduced Li content), Ni and Co. Accordingly, some aspects are directed to battery cells in which the cathode active material does not employ Li, Ni, and/or Co. One or more embodiments of the present disclosure are directed to particularly favorable combinations of cell anode, cathode, and electrolyte chemistries, architecture, and constructions as well as materials, cell designs and/or cell fabrication methodologies to overcome (or at least reduce reduce) some or all of the above-noted limitations of conventional cells. One or more embodiments of the present disclosure are directed towards the cell materials, cell design or cell fabrication methods to greatly improve one, two, three or more of the following important characteristics of cells (that do not rely on Li as a charge carrier for the anodes and cathodes): cell safety, cell stability and operation at elevated temperatures (e.g., above around 40° C.), rate performance at operational temperatures, energy density, cycle stability, calendar life, self-discharge, battery cell fabrication rate and complexity, energy consumption during battery cell fabrication and other key battery performance or cell manufacturing characteristics.

Some of the disclosed aspects may additionally improve the overall battery pack system, its safety, its weight and reduce its complexity (e.g., by eliminating cooling systems or additional safety features). Aspects of the disclosure are directed to an energy storage system comprising such battery pack(s) or described cells that would offer enhanced safety, reduced complexity, reduced cost, improved reliability and/or other desired features. Such a system may be used for energy storage at home (e.g., to complement installed solar cell systems) or in a centralized facility or in a vehicle (e.g., electric or hybrid electric) vehicle.

Note that suitable cell energy density, rate, cycle stability, thermal stability, safety and calendar life performance is not only defined by the chemistry of the active materials, but also by the surface chemistry, the construction (or architecture) of the electrodes, the type and weight and volume fractions of conductive additives and binder(s), the electrodes' density and porosity, the areal capacity loadings, the thickness of electrodes, the composition, thickness, microstructure, mesostructured, mechanical properties, surface area and type of the current collectors, the size and shape of the cells and many other parameters. Aspects of the present disclosure describes examples of suitable parameter ranges and methodologies to attain them.

In some applications, in order to reduce the relative fraction of inactive materials (e.g., current collector foils, separators, etc.), it may be highly advantageous to produce relatively thick cathodes (e.g., in some designs, in the range from about 60 micron to about 1000.0 micron; in some designs—in the range from about 60 micron to about 80 micron; in some designs—in the range from about 80 to about 100 micron; in some designs—in the range from about 100 to about 200 micron; in some designs—in the range from about 200 to about 400 micron; in some designs—in the range from about 400 to about 600 micron; in some designs—in the range from about 600 to about 800 micron; in some designs—in the range from about 800 to about 1,000.0 micron) that are also relatively dense (e.g., with the porosity in the electrode (pores between active (e.g., Na or K ion storing) material particles, conductive additives and the binder) in the range from about 10 vol. % to about 50 vol. %, or, in some designs, in the range from about 10 vol. % to about 20 vol. % or, in some designs, in the range from about 20 vol. % to about 30 vol. %; or, in some designs, in the range from about 30 vol. % to about 40 vol. %; or, in some designs, in the range from about 40 vol. % to about 50 vol. %). Lower porosity may increase cathode volumetric capacity but reduce rate. As such a suitable balance needs to be attained for a particular cell design meeting the customer specifications. Attaining good cell performance characteristics with cells comprising thick and relatively dense cathodes could be challenging. Aspects of the disclosure are directed to examples of suitable methodologies to overcome some or all of these challenges and produce high-performance cells with cathodes of preferable thickness and porosity.

In some designs, depending on the volumetric capacity of active particles in the cathodes, relative content of the binder and conductive additives and the porosity, the properties of the electrolyte and the cell specifications for particular applications, the areal capacity loading of the disclosed cathodes may preferably range from about 1.0 to about 50.0 mAh/cm²; in some designs from about 1.0 to about 2.0 mAh/cm²; in some designs from about 2.0 to about 3.0 mAh/cm; in some designs from about 3.0 to about 4.0 mAh/cm²; in some designs from about 4.0 to about 5.0 mAh/cm²; in some designs from about 5.0 to about 6.0 mAh/cm²; in some designs from about 6.0 to about 8.0 mAh/cm²; in some designs from about 8.0 to about 15 mAh/cm²; in some designs from about 15.0 to about 50.0 mAh/cm²). Attaining good cell performance characteristics with cells comprising high areal capacity loading cathodes could be challenging. Aspects of the disclosure are directed to examples of suitable methodologies to overcome some of these challenges and produce high-performance cells with cathodes of preferable areal capacity loadings.

High capacity, high energy batteries (e.g., cells with energy storage in excess of around 5 watt-hours (Wh); such as, in some designs, from about 5 to about 50,000 Wh; in some designs from about 5 to about 10 Wh; in other designs from about 10 to about 30 Wh; in other designs from about 30 to about 50 Wh; in other designs from about 50 to about 100 Wh; in other designs from about 100 to about 300 Wh; in other designs from about 300 to about 500 Wh; in other designs from about 500 to about 1000 Wh; in other designs from about 1000 to about 5,000 Wh; in other designs from about 5,000 to about 50,000 Wh) may particularly benefit from various aspects of this disclosure because such batteries are typically harder to produce and attain sufficiently good stability and other performance characteristics and may suffer particularly strongly from the above-discussed limitations of certain conventional cell fabrication methodologies and cell chemistries.

In some applications, to meet performance, form-factor, cost, and other targets, it may be preferable for the battery cells to exhibit a cylindrical shape. In some applications, it may also be preferable for the cells to be wound (rather than stacked), such as wound pouch cells, wound prismatic cells or wound cylindrical cells. Such designs, however, may be particularly challenging to attain with batteries comprising solid electrolytes or certain metal anodes. Various aspects of this disclosure address such a challenge and facilitate facile fabrication of (e.g., wound) cylindrical, wound prismatic or wound pouch cells with metal anodes and (in some designs) solid electrolyte.

In some applications (e.g., grid; transportation, various imbedded or integrated battery applications, etc.), it may be advantageous for the battery cells to attain extra-long calendar life (e.g., from about 5 to about 100 years; in some designs, from about 5 to about 10 years; in other designs, from about 10 to about 30 years; in other designs, from about 30 to about 50 years; in other designs, from about 50 to about 100 years; as estimated by using conventional testing protocols, including accelerated testing). Such long calendar life, however, may be particularly challenging to attain, especially with cells comprising conventional electrolytes and alkali metal ion cathodes. Various aspects of this disclosure address such a challenge and facilitate attaining long calendar life in battery cells.

In some applications (e.g., transportation; facility use; military use; energy storage to enable renewable energy, etc.), it may be advantageous for battery cells to attain low self-discharge at suitable (e.g., for storage) temperatures. For example, it may be advantageous for the cells to lose less than 20% of the initial capacity upon charging to 90% state-of-charge (SOC) (that is, to self-discharge from about 90% to more than about 70% SOC) when stored at suitable temperatures for a relatively long time (e.g., from about 4 days to about 40 years; in some designs, from about 5 days to about 1 month; in some designs, from about 1 month to about 6 months; in some design, from about 6 months to about 2 years; in some designs, from about 2 years to about 5 years; in some designs, from about 5 years to about 10 years; in some designs, from about 10 years to about 20 years; in some designs, from about 20 years to about 40 years). Attaining such low self-discharge rates during storage at suitable (for a given application) conditions (from about 5% per day on average for 4 days down to below 0.4% per year on average during 40 years; in some designs, from about 5% per storage day to about 0.6% per storage day; in some designs, from about 0.6% per day to about 0.1% per day; in some designs, from about 0.1% per day to about 10% per year; in some designs, from about 10% per year to about 4% per year; in some designs, from about 4% per year to about 2% per year; in some designs, from about 2% per year to about 1% per year; in some designs, from about 1% per year to about 0.5% per year), however, may be particularly challenging to attain, especially with cells comprising conventional electrolytes and alkali metal ion cathodes. Various aspects of this disclosure address such a challenge and facilitate attaining very low self-discharge rates in battery cells.

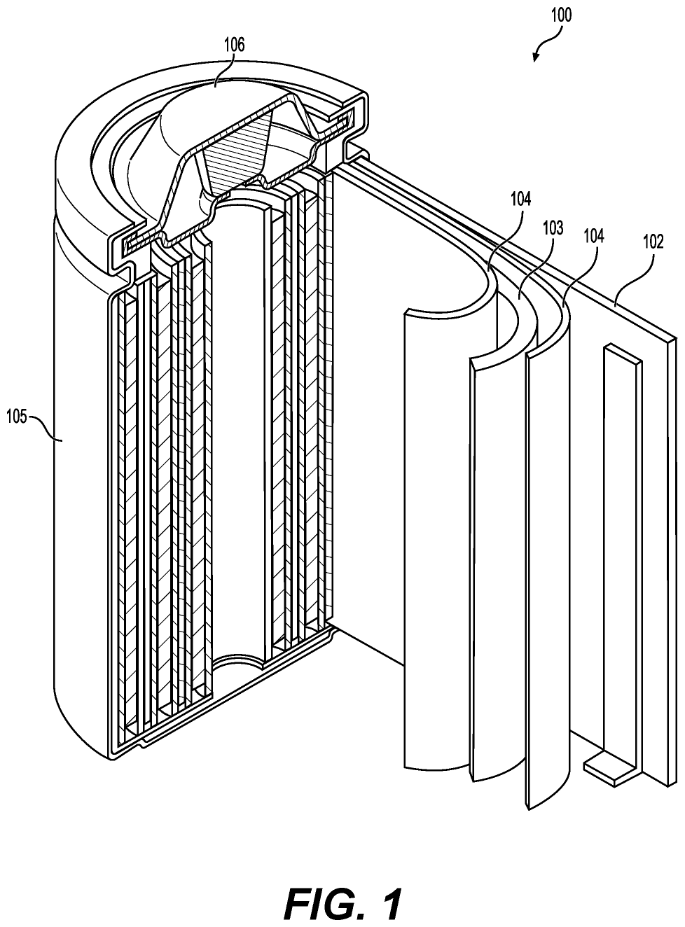

FIG. 1 illustrates an example battery 100 in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (not labeled separately) impregnating the separator 104 (and the cathode 103 and, in some designs, the anode 102), a battery case 105, and a sealing member 106 sealing the battery case 105.

In an aspect, an example battery cell is disclosed, wherein (i) the ion storage in the cathode active material is based on the reversible extraction/insertion of alkali metal ions (e.g., Na⁺, K⁺, Li⁺, etc. or their various combinations), (ii) the anode active material is aluminum (Al) metal or Al metal alloy and (iii) the electrolyte comprises both Al (e.g., in the form of ions comprising Al) and alkali metal atoms in at least some of the state of charge, wherein during cell charging alkali metal ions extracted (e.g., de-inserted) from the cathode displace at least some of the Al from the electrolyte and wherein the displaced Al is alloyed with or plated onto the anode (or the anode current collector). During discharge, the ions of alkali metal(s) (e.g., Na⁺, K⁺, Li⁺, etc.) are inserted back to the cathode active material from the electrolyte composition, while the Al extracted (e.g., de-alloyed or de-plated) from the anode is inserted back to the electrolyte composition. The electrolyte composition changes dynamically during the charging phase and the discharging phase of each of the repeated charge-discharge cycles. During the charging phase, a concentration of the Al (e.g., in the form of ions comprising Al, e.g., Al⁺, [AlCl₂]⁺, [AlCl₄]⁻, [Al₂Cl₇]⁻, [Al₃Cl₁₀]⁻, [Al₄Cl₁₃]⁻) in the electrolyte decreases and a concentration of the alkali metal ions in the electrolyte increases. During the discharging phase, the concentration of the Al (e.g., in the form of ions comprising Al) in the electrolyte increases and the concentration of the alkali metal ions in the electrolyte decreases. Accordingly, when the battery cell is in a fully discharged state, the concentration of the Al (e.g., in the form of ions comprising Al) in the electrolyte may be at or near maximum and the concentration of the alkali metal ions may be at or near minimum. Additionally, when the battery cell is in a fully charged state, the concentration of the Al (e.g., in the form of ions comprising Al) in the electrolyte may be at or near minimum and the concentration of the alkali metal ions may be at or near maximum. During a charge-discharge cycle (among repeated charge-discharge cycles) in which a battery cell is charged from a first fully discharged state to a fully charged state and then discharged to a second fully discharged state, the concentration of the Al in the electrolyte will be lower in the fully charged state than in the fully discharged states and the concentration of the alkali metal ions will be higher in the fully charged state than in the fully discharged states. The foregoing electrolyte may be referred to as a “displacement electrolyte”: during the charging phase, the first ions (e.g., Al-comprising ions that alloy with or plate with the anode, from the electrolyte) are displaced in the electrolyte by the second ions (e.g., alkali metal ions that de-insert from the cathode into the electrolyte), and during the discharging phase, the second ions (e.g., alkali metal ions that insert from the electrolyte into the cathode) are displaced in the electrolyte by the first ions (e.g., Al-comprising ions that de-alloy or de-plate from the anode into the electrolyte). The anode and cathode in such cells may be physically and electrically separated by either the electrolyte or the separator or both. The cell voltage is determined by the difference in the electrochemical potential between the cell cathode and the cell Al anode. Depending on the suitable cathode chemistry employed, the average discharge voltage of such cells may typically range from about 1 V to about 3 V (as measured at slow current densities of about C/10 to decrease the contributions of polarization resistance), while the maximum charge voltage may typically range from about 1.6V to about 3.7V and the minimum discharge voltage may range from about 0.01V to about 1.5V. Most typically, during cell full charge and full discharge cycles the cell voltage may change within the following range: from about 0.25V to about 3.25V.

In some designs, the cells may be assembled in a fully discharged state so that the ions of alkali metal(s) (e.g., Na⁺, K⁺, Li⁺, etc.) are already inserted into the cathode active material. In some designs, the cells may be assembled in a fully charged state so that the mobile ions of alkali metal(s) (e.g., Na⁺, K⁺, Li⁺, etc.) are not inserted into the cathode active material, but are only or mostly present in electrolyte. In some designs, the cells may be assembled in a partially charged or partially discharged state so that some of the alkali metal(s) ions (e.g., Na⁺, K⁺, Li⁺, etc.) are present in the cathode active material during cell assembling.

In some designs, the suitable cathode active material may comprise little (e.g., less than about 5 wt. %, or less than about 1 wt. %, relative to all alkali metal ions in the cathode) or virtually no (e.g., less than about 0.01 wt. % relative to all alkali metal ions in the cathode) lithium (Li). In some designs, the cathode active material may comprise primarily or only (e.g., about 50-100 at. % relative to all alkali metal atoms/ions in the cathode) Na. In some designs, the cathode active material may comprise primarily or only (e.g., about 50-100 at. % relative to all alkali metal atoms/ions in the cathode) K. In some designs, the cathode active material may comprise both K and Na. In some designs, the cathode may comprise two, three or more distinct (e.g., by composition or crystal structure or morphology) active material composition(s) during cell assembling. In some designs, two, three or more distinct active material composition(s) may comprise different alkali metal ions (or a different fraction of alkali metal ions). For example, one type of active material may be a Na-ion (or primarily Na-ion) cathode material and another type may be a K-ion (or primarily K-ion) cathode material. In some designs, different types of active material may exhibit distinctly different crystal structures and compositions even though the different types of active material may all comprise the same type of alkali metal ions. In some designs, the cathode active material may be of intercalation-type. In some designs, the cathode active material may be of conversion (including displacement)—type. Suitable examples of cathode active material and overall suitable cathode composition, properties and fabrication will be described in a separate section of the present disclosure in more detail.

In some designs, a suitable electrolyte may be a solid electrolyte (or at least partially or fully solid) at least during some portion of the cell operation conditions or storage. In some designs, a suitable electrolyte may comprise halide(s) (e.g., chlorides, bromides, iodides, etc.) or their various mixtures. In some designs, a suitable electrolyte may comprise Al halide (such as Al chloride, e.g., AlCl₃) or a mixed metal halide (such as a mixed metal chloride) comprising both Al and other metals (e.g., alkali metals, such as Na or K or Li or their various combinations, etc.). In some designs, a suitable electrolyte may comprise Al nitrate (e.g., Al(NO₃)₃) or a mixed metal nitrate comprising both Al and other metals (e.g., alkali metals, such as Na or K or Li or their various combinations, etc.) or their various mixtures. In some designs, a suitable electrolyte may comprise various organic and inorganic imide salts (including fluorinated organic salts with no H in their structure) of alkali metal ions (such as Na⁺ or K⁺ or Li⁺ or their various combinations, for example SO₂FN⁻(Na⁺)SO₂F (often abbreviated as NaFSI), CF₃SO₂N⁻(Na⁺)SO₂F, CF₃SO₂N⁻(Na⁺)SO₂CF₃ (often abbreviated as NaTFSI), CF₃CF₂SO₂N⁻(Na⁺)SO₂CF₃, CF₃CF₂SO₂N⁻(Na⁺)SO₂F, CF₃CF₂SO₂N⁻(Na⁺)SO₂CF₂CF₃, CF₃CF₂SO₂N⁻(Na⁺)SO₂CF₂CF₂CF₃, CF₃CF₂CF₂SO₂N⁻(Na⁺)SO₂CF₂CF₂CF₃, CF₃CF₂CF₂SO₂N⁻(Na⁺)SO₂CF₃, CF₃CF₂CF₂SO₂N⁻(Na⁺)SO₂F, C₄F₉SO₂N⁻(Na⁺)SO₂F, C₄F₉SO₂N⁻(Na⁺)SO₂CF₃, C₄F₉SO₂N⁻(Na⁺)SO₂C₂F₅, C₄F₉SO₂N⁻(Na⁺)SO₂C₃F₇, C₄F₉SO₂N⁻(Na⁺)SO₂C₄F₉, C₅F₁₁SO₂N⁻(Na⁺)SO₂F, C₅F₁₁SO₂N⁻(Na⁺)SO₂CF₃, C₅F₁₁SO₂N⁻(Na⁺)SO₂C₂F₅, C₅F₁₁SO₂N⁻(Na⁺)SO₂C₃F₇, C₅F₁₁SO₂N⁻(Na⁺)SO₂C₄F₉, C₅F₁₁SO₂N⁻(Na⁺)SO₂C₅F₁₁, CF₃SO₂N⁻(Na⁺)SO₂PhCF₃, and many others and their various in an illustrative example of Na⁺). In some designs, a suitable electrolyte may comprise salts of superacids. In some designs, a suitable electrolyte may comprise a eutectic mixture of salts at least during some SOC. In some designs, a suitable electrolyte may comprise one or more ionic liquid(s) of suitable composition, properties, at suitable weight and volume fraction(s) (relative to other electrolyte components; e.g., as an additive to improve conductivity or reduce charge transfer resistance on the anode or the cathode or improve Al plating morphology, etc.). In some designs, a suitable electrolyte may comprise one, two or more organic solvent(s) of a suitable composition, weight, and volume fraction(s) (relative to other electrolyte components, e.g., as an additive(s) to improve conductivity or reduce charge transfer resistance on the anode or the cathode or improve Al plating morphology, etc.). In some designs, a suitable electrolyte may comprise one, two or more nitride(s) of suitable composition(s), weight and volume fraction(s) (relative to other electrolyte components, e.g., as additive(s) to improve conductivity or reduce charge transfer resistance on the anode or the cathode or improve Al plating morphology, etc.).

In some designs, a suitable electrolyte may comprise ceramic nanoparticles (e.g., about 2-100 nm in average dimensions, such as diameter in case of spherical or spheroidal particles or diameter in case of elongated, fiber-shaped particles).

In some designs, a suitable electrolyte may exhibit a melting point in the range from about 40° C. to about 300° C. (e.g., at the electrolyte composition when cell is initially assembled or when the cell is nearly fully (e.g., to below about 10%) discharged). In some designs, the melting point of the electrolyte may range from about 60° C. to about 220° C.; in other designs, from about 40° C. to about 60° C.; in other designs, from about 60° C. to about 100° C.; in other designs, from about 100° C. to about 150° C.; in other designs, from about 150° C. to about 200° C.; in other designs, from about 200° C. to about 250° C.; in yet other designs, from about 250° C. to about 300° C.). In some designs, a suitable electrolyte may comprise a major (e.g., about 20-100 vol. %) component that exhibits a melting point in the range from about 40° C. to about 180° C. (e.g., at the electrolyte composition when cell is initially assembled or when the cell is nearly fully (e.g., to below about 10%) discharged). In some designs, a suitable electrolyte may be incorporated into a cell in a liquid state (e.g., in molten state or as a solution) during cell fabrication (e.g., at elevated temperatures). In some designs and cell manufacturing method(s), a suitable electrolyte may be incorporated into a cell at elevated temperatures (e.g., from around 60° C. to about 220° C.) in order, for example, to improve interfaces and interphases with electrodes, or, for example, to keep the electrodes and cell stack fully dried or, for example, to improve cell performance characteristics (e.g., attain better rate, cycle stability, calendar life, self-discharge, etc.).

Suitable examples of electrolyte components and overall suitable electrolyte composition, properties, fabrication, mechanisms or methodologies to incorporate electrolyte into the cell will be described in a separate section of the present disclosure in more detail. In some designs, a suitable electrolyte may be incorporated into a cell by direct coating on the anode or cathode. In some designs, the electrolyte may be liquid during coating and solid during the remainder of the cell manufacturing process. In some designs, a suitable electrolyte may be incorporated into a cell by mixing solid or liquid electrolyte into the cathode coating slurry. In some designs, a suitable electrolyte may be incorporated into a cell by double coating the cathode foil, first with cathode or cathode and electrolyte slurry, followed by a second coating of electrolyte.

In some designs, a suitable anode may be an Al metal or an Al metal alloy. Suitable examples of anode components and overall suitable anode composition, properties, fabrication, mechanisms and methodologies to incorporate into the cell will be described in a separate section of the present disclosure in more detail.

In some designs, a suitable separator may be a polymer separator or a polymer-comprising separator. In some designs, the separator may comprise natural fibers (e.g., cellulose fibers). In some designs, a suitable separator may be a polymer-ceramic or a polymer-glass composite separator. In some designs, such a composite separator may comprise ceramic (or glass)-rich and ceramic (or glass)-poor (or ceramic/glass-free) sections. In other designs, such a composite separator may comprise a relatively uniform mixture of ceramic (or glass) and a polymer or mixture of polymers. In some designs, a suitable separator may comprise primarily (e.g., about 75-100 wt. %) ceramic (or glass). In some designs, ceramic (or glass) components of the separator may be in the shape of the spherical or near spherical particles. In some designs, ceramic (or glass) components of the separator may be elongated into fiber (e.g., nanofiber or nanowire) shape to attain higher porosity (lower packing density), provide better mechanical properties and offer other advantages. In some designs, ceramic (or glass) components of the separator may comprise flake-shaped particles (e.g., to provide better mechanical properties and better protection against dendrites or stresses during cycling). In some designs, ceramic (or glass) components of the separator may comprise oxides or hydroxides or oxyhydroxides of Al, Si, Mg, P, Na, B, Zr, or Ca or their various combinations. In some designs, a suitable separator may comprise distinct layers. In some designs, a suitable separator may be porous an impregnated (infiltrated) with a suitable electrolyte. In some designs, a suitable separator may be largely nonporous and at the same time ionically conductive for Al or Al-comprising ions. In some designs, a suitable separator may be a standalone membrane that is sandwiched between the anode and cathode. In other designs, a suitable separator may be integrated onto (e.g., deposited onto) one or more of the following: the surface of the anode, the surface of the anode current collector and/or the surface of the cathode. Suitable examples of separator components and overall suitable separator composition, properties, fabrication, mechanisms and methodologies to incorporate into the cell will be described in a separate section of the present disclosure in more details.

In some designs, a suitable anode current collector may be an Al-comprising (in some designs, comprising about 20-100 wt. % of Al) foil (including porous or perforated foils), Al-comprising (in some designs, comprising about 20-100 wt. % of Al) foam, or Al-comprising (in some designs, comprising about 20-100 wt. % of Al) mesh. In this design, any losses of electrochemically active Al atoms in the anode during cycling and mostly reversible Al storage (e.g., by electrochemical plating during charge and dissolution during discharge or the formation of electrochemical Al alloys during charge and their partial dissolution during discharge) may be compensated by the additional Al atoms present in the current collectors. In some designs, a suitable anode current collector may comprise significant amount of Al per geometrical area. In some designs, an anode current collector during cell assembling may comprise as much as about 10 at. %-5000 at. % of Al that needs to be stored (e.g., deposited) on the anode during the first or second full charge (e.g., to about 95-100% SOC) (in some designs, from about 10 at. % to about 50 at. % of Al; in other designs, from about 50 at. % to 100 at. % of Al; in other designs, from about 100 at. % to 200 at. % of Al; in other designs, from about 200 at. % to 400 at. % of Al; in other designs, from about 40 at. % to 1000 at. % of Al; in other designs, from about 1000 at. % to 5000 at. % of Al). In some designs, such Al-comprising anode current collector may be made of Al or Al-comprising alloy (e.g., Zn—Al alloy, among others). In some designs, Al alloys in the anode current collector may comprise (in the amount exceeding about 0.001 wt. % or, in some designs, exceeding about 0.01 wt. %) one, two, three, four or more of the following metals or semimetals: Zn, Mg, Zr, Ti, Ta, Be, B, Sc, Na, Li, Bi, Mn, Cr, W, Mo, Fe, Cd, Co, Pb, Ni, Nb, Sb, Sn, Si, Cu, Ag, V, Ga, Cu, Mn, Si, Mg, Zn, Fe, Ti, Zr, Ni, Cs, Y and Ce, Na, Ag and Li. In some designs, it may be advantageous for the metal or metal alloys to exhibit average grain size in the range from about 0.5 nm to about 500 nm (e.g., about 0.5-2 nm or about 2-10 nm or about 10-50 nm or about 50-200 nm or about 200-500 nm).

In some designs, Al-comprising current collector may comprise a foil or a mesh of another metal or metal alloy (e.g., Zn or Zn alloy, Cu or Cu alloy, W or W alloy, Mo or Mo alloy, Fe or Fe alloys including steel and stainless steel, Ni or Ni alloy or their various alloys and combinations, etc.) coated with Al or Al alloy on one or all sides (e.g., deposited by electro-plating, by electroless plating or by sputtering or other suitable means). In some designs, Al-comprising current collector may comprise another metal or metal alloy (e.g., Zn or Zn alloy, Cu or Cu alloy, W or W alloy, Mo or Mo alloy, Fe or Fe alloys including steel and stainless steel, Ni or Ni alloy or their various alloys and combinations, etc.) foil sandwiched between two Al foils. In some designs, a suitable anode current collector may be a Zn-comprising foil (including porous or perforated foils) or a Zn-comprising mesh. In some designs, the use of a suitable non-Al metal (e.g., Zn) may ensure that the mechanical integrity of the anode current collector remains largely intact despite repeated cycles of Al deposition and dissolution. In some designs, the use of a suitable non-Al metal (e.g., Zn) may also allow one to maintain the required electrical conductance in the anode current collector despite possible Al losses during cycling. In some designs, the anode current collector may comprise carbon. In some designs, the carbon in the anode current collector may be in the form of a (mostly) continuous coating. In some designs, the carbon in the anode current collector may be present in the form of carbon particles (e.g., carbon black, carbon nanotubes, graphene, graphene oxide, reduced graphene oxide, exfoliated graphite, hard carbon, soft carbon, carbon ribbons, dendritic carbon, carbon fibers, carbon nanofibers, etc.). In some designs, the carbon in the anode current collector may be present mostly on the surface of the current collector. In other designs, the carbon in the anode current collector may be present in the bulk (interior) of the current collector. In some designs, suitable polymer binder may be used to attach carbon particles to each other and the substrate (e.g., suitable metal or metal alloy foil or mesh, etc.). In some designs, the presence of carbon in the anode current collector may improve cell stability, reduce cell resistance, or reduce cell resistance growth during cycling or provide other performance benefits. In some designs, the anode current collector may advantageously comprise one or more of (in some designs, conductive) filaments (e.g., fibers or nanofibers, microwires or nanowires, etc.), (e.g., conductive) flakes, (e.g., conductive) nanoparticles (including conductive particles having random, spherical, spheroidal or dendritic shapes) made of one or more of the following compositions: conductive polymers, conductive carbon, conductive carbides (e.g., MXenes), heavily doped and thus conductive semiconductors (e.g., Si, Sn, Sb), and metals and metal alloys (e.g., metal and metal alloys based on or comprising Al, Zn, Cu, Ni, Fe, Ti, Mg, or Ag, etc.). The presence of these conductive particles (particularly on the current collector surface) may improve cell stability, reduce cell resistance, or reduce cell resistance growth during cycling or provide other performance benefits. In some other designs, such fillers in the anode current collector may be not electrically conductive.

In some designs, a suitable thickness of the anode current collector may range from about 5 micron to about 500 micron (in some designs, from about 5 to about 15 micron; in other designs, from about 15 to about 30 micron; in yet other designs, from about 30 to about 50 micron; in yet other designs from about 50 to about 500 micron). Too thin anode current collector may not provide sufficient mechanical rigidity, mechanical integrity or conductivity or may limit the battery cycle life. Too thick anode current collector may reduce energy density and specific energy characteristics of the cell and contribute to unacceptable price increase. In some designs, it may be advantageous for the anode current collector to be porous or exhibit surface roughness so that the surface area of the current collector exposed to electrolyte (in contact with electrolyte) exceeds its geometrical surface area by a meaningful degree (e.g., by about 10% to about 50,000% or by approximately 1.1-500 times; in some designs, for example, by about 10-100%; in other designs, by about 100-200%; in other designs by about 2-5 times; in other designs, by about 5-20 times; in other designs, by about 20-100 times; in yet other designs, by about 100-500 times). Higher surface area of the current collector in contact with electrolyte may provide higher surface for Al deposition (or electrochemical alloying/dealloying), thus effectively reduce the area-normalized current density, and thus increase cell power density (enable faster charge and discharge rates), reduce resistance, improve uniformity of the Al deposition/dissolution (or electrochemical alloying/dealloying), improve cycle stability and other battery cell characteristics. Suitable examples of anode current collector components and overall suitable anode current collector composition, properties, fabrication, mechanisms and methodologies to incorporate into the cell will be described in a separate section of the present disclosure in more detail.

In some designs, a suitable cathode current collector may be Al or Al alloy foil, foam, or mesh. In some designs, a suitable cathode current collector may comprise a layer of conductive carbon paint (a mixture of conductive carbon and a polymer binder) to reduce interfacial resistance or protect the current collector from corrosion. Suitable examples of cathode current collector components and overall suitable cathode current collector composition, properties, fabrication, mechanisms and methodologies to incorporate into the cell will be described in a separate section of the present disclosure in more detail.

In the simplest design, a suitable cathode may comprise a low-cost intercalation-type active material particle type, with each intercalation-type active material particle comprising only one species of mobile alkali metal ions. Herein, the term “only one species of mobile alkali metal ions” is used to refer to, for example, only Na ions or only K ions. In some more sophisticated designs, more than one alkali metal ion species may be reversibly stored in the same active material particles. In some designs, a reason for comprising more than one alkali metal ion (e.g., both Na and K or Na, K and Li in suitable concentrations) in an active material may be attaining higher conductivity or lower melting point (or both) of electrolyte that similarly comprise more than one alkali metal ion species. In some designs, incorporating larger alkali metal ions (e.g., K) into the active material that primarily comprise smaller alkali metal ions (e.g., Na or Li) may be used to increase lattice spacing and accelerate the diffusion of these smaller alkali metal ions in/out of the active material (e.g., to attain higher charging rates for approximately the same size distribution cathode particles). Another illustrative motivation for incorporating certain alkali metal ions (e.g., K) into the active material that primarily comprise other alkali metal ions (e.g., Na) may be to increase average discharge voltage. Yet another illustrative motivation for incorporating certain alkali metal ions into the active material that primarily comprise other alkali metal ions may be reduced volume changes or better cycle stability. Other performance or cost benefits may also be attained when combining several alkali metal ions into the active material structures.

In the simplest design, a suitable cathode may comprise only one type of active material particle. For example (in the simplest case of a single alkali metal ion in active material particles), only one type of, for example, sodium (Na) layered metal oxides (e.g., manganese oxide-based cathode materials) or only one type of, for example, potassium (K) layered metal oxides (e.g., manganese oxide-based cathode materials) or only one type of, for example, sodium (Na) olivine structures (e.g., sodium iron phosphate or sodium manganese iron phosphate, etc.) or only one type of, for example, potassium (K) olivine structures (e.g., sodium iron phosphate or sodium manganese iron phosphate, etc.) or only one type of, for example, sodium (Na) Prussian Blue (Prussian White) analogs or only one type of, for example, potassium (K) Prussian Blue (Prussian White) analogs, or only one type of, for example, sodium (Na) spinel metal oxides (e.g., spinel manganese oxide-based cathode materials or spinel vanadium oxide-based cathode materials, etc.), or only one type of, for example, potassium (K) spinel metal oxides (e.g., spinel manganese oxide-based cathode materials or spinel vanadium oxide-based cathode materials, etc.), etc. In some more sophisticated designs, more than one active material particle type may be used in the construction of the suitable cathode. Such an approach may, for example, enable faster rate performance from one type of active material (e.g., for pulse power performance requirement) while providing more energy from another type of active material (e.g., for higher energy density or higher specific energy requirements). In another illustrative example, one material may provide, for example, more energy, but shorter cycle life and another material may provide much better cycle life but not sufficient energy density to be used only by itself. In an application where the better cycle life cathode material is used primarily (for regular use, where full discharge is rarely achieved), while another (e.g., higher energy material) is discharged (and charged) only occasionally the use of several active materials in a single cell may be advantageous. In another illustrative example, one active material may, for example, slightly expand during discharge, while another active material may, for example, slightly contract during charge to ensure that overall electrode-level volume changes are small. These examples are for illustration only and other performance or cost benefits may be attained by combining multiple active materials within the same cell.

In some aspects of the present disclosure, active cathode materials may comprise Prussian Blue (PB) (or Prussian White (PW)) or various PB analogs (PBAs) with approximate composition of X₂M1[M2(CN)₆], where X=Na, Li, K (alkali metals) or their various combinations, where each of M1 and M2 is independently=Fe, Co, Mn, Ni, Cu, Ti, Zn and other transition-metals and their various combinations and mixtures (note M2 is most commonly Fe, although it may be partially or fully substituted with Mn and other transition metals such as Mn, Ni, Zn, Cu, etc.). In addition to main M1 and M2 metals, various dopants may be used to fine-tune chemical, electrical and electrochemical properties of such materials for superior performance in particular applications. Furthermore, such materials may benefit from functional surface coatings (e.g., preferably between about 0.3 nm and about 30 nm in average thickness) to improve rate, chemical, thermal, and electrochemical stabilities and various cell performance characteristics. Note that the atomic ratio of alkali metal ions to transition metal ions M1 and to transition metal ions M2 may not be exactly 2:1:1, but instead vary in a broader range of (from 0 to 2):1:(from 0 to 1) so the more general formula may be X_{y1}M1[M2(CN)₆]_{y2}, where 0<y1<2 and 0<y2<1. These are a large family of hexacyanoferrates with open framework structure, abundant redox sites, and good structural, chemical, and thermal stabilities and have very small volume changes, which may be highly advantageous in some of the disclosed cell design due to cell fabrication (and operation) at elevated temperatures and limited compressibility of solid electrolytes (in contrast to, say, liquid electrolytes). In some designs, large ionic channels and interstices in the lattice in PB and PBAs may facilitate these materials to accommodate not only Li⁺, but also much larger alkali metal cations, such as Na⁺ and K⁺ ions, for fast and reversible ion insertion/extraction (intercalation/de-intercalation) reactions. In some designs, each molecular formula of PBs or PBAs contains two redox centers: (i) M (typically +2/+3) and (ii) Fe (+2/+3), which may enable them to reversibly store two ions (e.g., 2 Na⁺) per molecular unit. For example, in case of Na₂FeFe-type PB (M1=M2=Fe), specific capacity over (>) 160 mAh/g and average discharge potential>3 V vs. Na/Na⁺ may be attained; in case of Na₂MnMn-type PB, specific capacity>200 mAh/g and average discharge potential>3.5 V vs. Na/Na⁺ may be attained; in case of Na₂MnFe-type PB, specific capacity>150 mAh/g and average discharge potential>3.5 V vs. Na/Na⁺ may be attained. K-ion versions of PB/PW and PBAs typically offer even higher average discharge potential, although the larger size and weight of K⁺ ions may induce lower volumetric and gravimetric capacities, in some designs. The chemical and physical properties of such materials may also vary depending on their composition. So, a proper balance between K and Na content (from 1:0 to 0:1) in such materials may preferably be identified for optimal performance in Li-free (or mostly Li-free) cells.

One significant limitation of PB/PW and PBAs is their very high hygroscopicity and their poor performance (lower capacity, lower rate, faster degradation during cycling and storage, etc.) when hydrated. So even when cathodes are properly dried, even a moderate exposure to remaining moisture in a dry-room or a glovebox may reduce their performance. To overcome this challenge using one of the aspects of the present disclosure, one may fill the dry cells (e.g., jelly roll) with the electrolyte while keeping the cells hot (e.g., in some designs above around 80° C.; preferably above around 100° C.; most preferably above around 120° C.; in some designs, above around 140° C.). Higher temperature may reduce contaminants and improve performance, although too high temperature may also induce degradation of a binder or excessive evaporation of electrolyte (in some designs, heated to approximately the same temperature). As such, optimal filling temperature may preferably be found for a particular cell (including binder and separator) chemistry. Many of the disclosed electrolytes exhibit high melting point and high vaporization or decomposition points and thus would be particularly suitable for the disclosed cell fabrication method.

In some designs, a suitable cathode active material may be a layered mixed metal oxide. In one of the simplest design, such a cathode may exhibit a formula X_{y0}M1_{y1}M2_{y2}M3_{y3}M4_{y4}O₂, where X=Na, Li, K (alkali metals) or their various combinations, where each of M1, M2, M3, and M4 is independently=Fe, Mn, Ti, Cu, Zn, Al, Zr, Mo, W, Ni, Co, Cr, V and other transition-metals and their various combinations and mixtures, where M1_{y1}M2_{y2}M3_{y3}M4_{y4}O₂ may often form near-hexagonal sheets when the cathode is fully discharged (fully intercalated with alkali-metal ions), where typically 0.65<y₀<1.25 (often 0.7<y₀<1 or =1 or around 1) and 0.8<y₁₊y₂₊y₃₊y₄<1.05 (often y₁₊y₂₊y₃₊y₄=1 or around 1) when the cathode is fully discharged (fully intercalated with alkali-metal ions). In some designs, less than 4 or more than 4 transition metals may be present in such layered oxides (note that some transition metals may be present at a dopant level of below about 1 at. %). In some designs, some of the alkali metal ions (typically up to about 30 at. %) or transition metal ions (typically up to 15 at. %) may be partially replaced or doped with divalent alkaline earth metals (e.g., Ca, Mg, etc.—typically up to about 30 at. %). In some designs, the amount of Co and Ni may be kept to a minimum (or such metals may not be used at all, if acceptable performance may still be attained) to minimize the use of rare or expensive transition metals. In some designs, the amount of Co, Cr and V may be kept to a minimum (or such metals may not be used at all if acceptable performance may still be attained) because of their relatively high toxicity. In some designs, the amount of Ti and Al may be kept to a minimum (to attain satisfactory performance) or not used at all since such metals are typically inert (not electrochemically active) when used in such cathodes. Illustrative examples of such materials (in case of pure Na-ion cathode active materials) include but are not limited to Na_{0.66}Mn_{0.67}Ni_{0.36}Zn_{0.07}O₂, Na_{0.67}Mn_{0.67}Ni_{0.33}O₂, Na_{0.76}Mn_{0.5}Ni_{0.3}Fe_{0.1}Mg_{0.1}O₂, NaMn_{0.25}Ni_{0.25}Fe_{0.25}Mg_{0.25}O₂, NaNi_{0.5}Mn_{0.3}Ti_{0.2}O₂, Na_{0.67}Fe_{0.5}Mn_{0.5}O₂, Na_{0.67}Mn_{0.72}Mg_{0.28}O₂, Na_{0.78}Mn_{0.67}Fe_{0.11}Cu_{0.22}O₂, Na_{0.9}Mn_{0.48}Fe_{0.3}Cu_{0.22}O₂, among many others.

In some designs, layered metal oxide may be alkali metal-vanadium oxides. In some illustrative (simple, undoped, pure Na-ion based) cathode materials examples, such layered oxides may include, but are not limited to X_{y0}V₂O₅, X_{y0}V₃O₈, X_{y0}VO₂, among others, where 0.3<y0<2 (in which the particular y0 value may depend on the particular microstructure).

In some aspects of the present disclosure, active cathode materials may comprise polyanionic compounds. Such materials may offer enhanced thermal stability and tolerance to over-charge and over-discharge. The most common and suitable examples of intercalation compounds with polyanionic groups include those that comprise one, two or more of such groups as (SO₄)²⁻, SO₄F³⁻, (PO₄)³⁻, (NO₃)¹⁻, (PO₂F)²⁻, (PO₃)³⁻, (PO₃F)²⁻, (P₂O₇)⁴⁻, (AsO₄)³⁻, (MoO₄)²⁻, (BO₄)⁵⁻, (BO₃)³⁻, (MnO₄)⁻, (SiO₄)⁴⁻, (SO₄)²⁻, (SO₃)²⁻, (WO₄)²⁻, (Cr₂O₇)²⁻, (CO₃)²⁻, (C₂O₄)²⁻, (F)⁻, (F₂)²⁻, (F₃)³⁻, among others. These may include olivine (including but not limited to phosphates, fluorophosphates, etc.), NASICON-like, orthorhombic and tetragonal cathode structures, among others. In addition to alkali metals (e.g., Na, K, or Li or their various combinations), such cathodes may commonly comprise one, two or more transition metals, such as Fe, Mn, V, Zr, Mo, W, Ti, Ni, Co, Cu, Cr, and their various combinations, among others. In some designs, some of the (e.g., transition) metals or semimetals or alkaline earth metals may be used as dopants to polyanionic cathodes to enhance their stability or rate performance or to reduce volume changes in such materials during cycling. In some designs, transition metal oxides may be used instead of transition metals (e.g., VO instead of V).

Illustrative examples of suitable Fe- or Mn-comprising polyanionic cathode materials (in case of pure Na-ion cathode active materials) may include but are not limited to NaFePO₄, Na₂FePO₄F, NaMnPO₄, Na₂MnPO₄F, Na₂FeMnP₂O₅, Na₄FeMnP₂O₈F₂, NaFeSO₄F, NaMnSO₄F, Na₄Fe₃(PO₄)₂(P₂O₇), Na₄Mn₃(PO₄)₂(P₂O₇), Na₄MnFe₂(PO₄)₂(P₂O₇), Na₄Mn₂Fe(PO₄)₂(P₂O₇), among many others.

Illustrative examples of suitable V-comprising materials (in case of pure Na-ion cathode active materials) may include but are not limited to Na₃(VO)₂(PO₄)₂F, Na₃V₂(PO₄)₃, NaVO(PO₄), NaVPO₄F, Na₃V₂(PO₄)₂F₃, Na₃V₂(PO₄)₂FO₂, Na₇V₃(P₂O₇)₄, Na₇V₄(P₂O₇)₄(PO₄), Na₃V(PO₃)₃N, Na₃(VO₁₋ₓPO₄)₂F₁₊₂ₓ (0≤x≤1), Na_{0.8}VOPO₄, among many others.

In some designs, a suitable cathode active material may be a spinel-structured material. The interstitial space of the spinel framework provides 3D channels for high-rate ion diffusion, which may be particularly advantageous for Na⁺ and K⁺, which are larger than Li⁺. The most common examples of such materials are based on Mn or Mn—Ni oxides. Illustrative examples of suitable Mn-comprising materials (in case of pure Na-ion cathode active materials) may include but are not limited to NaMn₂O₄, NaNi_{0.5}Mn_{1.5}O₄, Na(Ni—Mn—Fe)₂O₄, Na(Ni—Mn—Fe)O₂, NaMnSiO₄, and their various combinations, among others. In some designs, such spinel cathode materials may be doped (e.g., at about 0.001-6.000 at. % level relative to all metals in the cathode active material) by transition metals, such as Cr, Fe, Ni, Ti, Cu, Zn, Al, Zr, Mo, W, Co, Cr, V, among others.

In some designs, a suitable cathode active material may be multi-electron redox materials (including but are not limited to conversion-type electrode materials) with high specific and volumetric capacities, although typically at lower voltages compared to many intercalation-type compounds discussed above. The multi-electron reaction involves at least one atom per formula unit (such as transition metals, chalcogens) as redox center which undergoes valence changes by more than one electron. Conversion-type cathode materials may offer particularly high specific and volumetric capacities.

Illustrative examples of suitable conversion-type (or mixed intercalation-type and conversion-type) cathode materials (in case of pure Na-ion cathode active materials) may include but are not limited to (i) various metal fluorides (such as sodium fluorides (e.g., NaF) in combination with suitable metals (Fe, Ni, Cu, Bi, Zr, Zn, W, Mn, and their various combinations); as well as various metal iron fluorides (FeF₃ or FeF₂), manganese fluoride (MnF₃), cobalt fluoride (CoF₃ or CoF₂), cupper fluoride (CuF₂), nickel fluoride (e.g., NiF₂), lead fluoride (e.g., PbF₂), bismuth fluorides (BiF₃ or BiF₅), tin fluoride (SnF₂ or SnF₄), antimony fluorides (SbF₃ or SbF₅), cadmium fluoride (CdF₂), zinc fluoride ZnF₂, and other metal fluorides and their various mixtures), (ii) various metal oxyfluorides (e.g., comprising two, three or more of Na, K, Fe, Ni, Cu, Nb, Bi, Zr, Zn, W, and Mn metals, and their various combinations), (iii) various metal chalcogenides (such as sodium sulfide Na₂S, lithium selenide Na₂Se, sodium telluride Na₂Te, and others); (iv) various metal chlorides or oxychlorides (such as sodium chlorides (e.g., NaCl), iron chlorides (FeCl₃ or FeCl₂), manganese chloride (MnCl₃), cobalt chloride (CoCl₃ or CoCl₂), copper chloride (CuCl₂), nickel chloride (NiCl₂), lead chloride (PbCl₂), bismuth chlorides (BiCl₃ or BiCl₅), cadmium chlorides (CdCl₂), zinc chlorides (ZnCl₂), and other metal chlorides and their mixtures); (v) various metal bromides and oxybromides (such as sodium bromide NaBr); (vi) various metal iodides (such as sodium iodide NaI); (vii) various mixed metal fluorides, mixed metal chlorides, mixed metal bromides, mixed metal iodides, mixed metal halides (a mixture of two or more metal halides, such as CuF₂ and FeCl₂ or CuF₂ and FeF₃, etc.), mixed metal oxyfluorides; (viii) various other conversion-type electrodes, their combination and mixture (e.g., sulfides, oxides, nitrides, halides, phosphides, hydrides, etc.); (ix) various metal sulfides and metal selenides and their various combinations (e.g., Na₂S, FeS, Ni₃S₂, VS₂, TiS₂, SnS₂, etc., and their combinations); (x) mixtures and combinations of intercalation-type Na-ion battery active materials and conversion-type active materials or active materials exhibiting both intercalation and conversion-type (including displacement-type) ion-storing reactions, to name a few examples. It will be appreciated that these (e.g., conversion-type) volume changing active cathode materials may be utilized in both Na-free or partially sodiated or fully sodiated state(s). In some cases, the use of partially or fully sodiated state(s) of active materials may be particularly advantageous for a selected synthesis process (e.g., if only the sodiated state is sufficiently stable for a particular processing/synthesis route). It will be appreciated that partially or fully sodiated conversion-type active materials may be composites. In some examples such composites may comprise metals. For example, if metal halides (e.g., CuF₂ or FeF₃ or others) are fully sodiated they become a mixture (composite) of a sodium halide (e.g., NaF in the case of metal fluorides) and metal clusters (or nanoparticles) of the corresponding metal fluoride (e.g., Cu, Fe, Ni, Cu—Fe, Cu—Ni, Fe—Ni, and Cu—Fe—Ni mixtures in the case of CuF₂, FeF₂ or FeF₃, NiF₂, CuFe₂—FeF₃, CuFe₂—NiF₂, NiFe₂—FeF₂, CuFe₂—NiF₂—FeF₂—FeF₂ mixture, respectively). Also note that in case when a solid electrolyte is used in some embodiment of the present disclosure, it may be highly advantageous to utilize cathodes in a fully expanded (e.g., sodiated) state during the cell assembling.

In some designs, it may be advantageous, for the disclosed cell design, to select a polymer (e.g., in an electrode binder or in a polymer separator) that exhibits thermal stability sufficient to withstand heating during the electrolyte infiltration (e.g., melt-infiltration) process (e.g., a polymer that exhibits no more than about 5 wt. % weight loss during exposure at the electrolyte infiltration conditions for about 1 to 20 minutes). In some designs, instead of an organic polymer binder or an organic polymer separator, one may use an inorganic polymer binder (or separator) or a hybrid organic-inorganic material to achieve the desired thermal stability and wetting. In some designs, thermal stability of the binder may be significantly enhanced if a ceramic material (e.g., an oxide or nitride or carbide or fluoride or sulfide or another suitable ceramic material(s); in some designs comprising Li, Na, K, Mg, Ca, Al, Cr, Zr, Zn, Si, Ni, Mo, La, Y, or W, among other suitable metals and semimetals) is infiltrated into the polymer binder structure (e.g., by means of ALD or other vapor deposition or vapor infiltration or other methods) and/or deposited on its surface (e.g., by means of ALD or other vapor deposition or vapor infiltration or other methods) before the melt-infiltration with the electrolyte (after the electrode fabrication in case of the binder and after the membrane fabrication or deposition in case of a separator). In some designs, it may be advantageous if the binder forms a fibrous structure so that a portion of the electrode particles are not coated with the binder. In some designs, it may be advantageous to use a combination of two or more distinct binder materials with substantially different thermal stability (e.g., by about 25° C. or more), substantially different affinity to the electrode particles (e.g., so that one binder preferentially coat the particles), substantially different permeability by the vapors during ALD (e.g., so that one of the binder incorporates substantially larger quantities (e.g., by about 25% or more larger) of the ceramic material) and/or substantially different shape (e.g., one forming conformal films and another one forming fiber-shaped net).

In some designs, a polymer in the binder or separator membrane may be halogenated (e.g., fluorinated, chlorinated, etc.) to enhance its thermal properties or chemical stability or wetting by the molten solid electrolyte. In some designs, a weakly bonded hydrogen (H) (e.g., in the form of alcohol or carboxy groups, etc.) in a polymer in the binder or separator membrane may be replaced with another metal (K, Li, Na, Cs, etc.) to reduce or prevent H₂ evolution during heating or melt infiltration by the SSE.

In some designs, a polymer in the binder or separator membrane may be cured via treatments (i) at high temperatures (e.g., from around 100° C. to around 400° C.) and/or (ii) high pressures (for example, from around 2 atm to around 1000 atm) and/or (iii) chemically reductive (or, the opposite—(iv) chemically oxidative) environment in order to enhance its thermal properties or chemical stability or wetting by the molten solid electrolyte.

In some designs, it may also be preferred for the binder material not to undergo substantial (e.g., above around 5-10 vol. %) shrinkage during the heat treatment and thus the binder composition may be selected accordingly. In some designs, the binder material may be selected to become ceramic after the electrode heat-treatment process (e.g., if the binder material is selected from a broad range of the precursors for polymer-derived ceramics). In some designs, the binding material (or a portion of the binder materials) may be vapor-deposited (e.g., by using vapor infiltration, chemical vapor deposition (CVD), atomic layer deposition (ALD), or other suitable processes) on the porous electrode surface (e.g., as a conformal or at least partially conformal coating), connecting individual electrode particles together. In this case, such a coating acts as a binder (and in some cases, as a protective layer). In some designs, such a coating may comprise an oxide layer. In some designs, such a coating may be electrically conductive. In some designs, such a coating may comprise two or more layers. In some designs, such a coating may comprise a metal (preferably selected to exhibit a melting point at least about 100° C. above the melt-infiltration temperature and relatively slow reactivity with the molten electrolyte) or a carbon. In some designs (e.g., when the ionic conductivity of such a coating is low), it may be preferable that the coating covers no more than around 90% (more preferably no more than about 80% or even more preferably no more than about 60%) of the surface area of the individual active particles in the electrode.

In some designs, the disclosed cathodes may comprise single-use particles based on alkali metal salt (e.g., NaN₃, NaP₃ or NaO₂-based or others in case of pure Na-ion cathode) to provide additional source of alkali metal ions (e.g., Na⁺ in case of pure Na-ion cathode) if some of such ions may be irreversibly lost during the initial cycling or if alkali-metal deficient active cathode materials (e.g., Na-deficient in case of Na-ion cathode materials) are used during the cell assembling.

In some designs, the cathode material may advantageously comprise thin (e.g., protective) coating (in some designs from around 0.5 nm up to around 100 nm; in some designs—from around 0.5 nm to around 2 nm; in other designs from around 2 nm to around 5 nm; in other designs from around 5 nm to around 10 nm; in other designs, from around 10 nm to around 100 nm) in order to reduce interfacial (or interphase) resistance, improve chemical or mechanical stability of the interface (or interphase) or minimize undesirable reactions between the cathode and electrolyte, particularly at elevated temperatures (since some of the disclosed designs may include battery assembling and use at relatively high temperatures). In some of such designs, such a coating may comprise a phosphate, conductive carbon, conductive polymer (e.g., a polymer exhibiting ionic or electronic or mixed conductivity), carbide, oxide, oxyfluoride, fluoride or their various mixtures and combinations. In some designs, such a coating may comprise pores (e.g., in order to accommodate stresses at the active material-electrolyte interface/interphase).

In some designs, the protective coating(s) or coating(s) may be deposited onto the surface of cathode particles (e.g., conformably) or on the surface of the cathode from a vapor phase via vapor deposition techniques. Examples of such techniques include, but are not limited to, chemical vapor deposition (CVD) including plasma-enhanced CVD, atomic layer deposition (ALD) including plasma-enhanced ALD, vapor infiltration, and others. For some designs, the protective material may be deposited from a solution. Examples of suitable techniques include sol-gel, layer-by-layer deposition, polymer adsorption, surface-initiated polymerization, nanoparticles adsorption, spray drying, layer-by-layer deposition, electroless deposition, electrodeposition, electrophoretic deposition, and others. In some designs, the shell formation may involve multiple stages, where initially the shell precursor is first deposited conformably in a solution and then is transformed (at least, in part) into the shell material via thermal decomposition and/or chemical reaction. In some designs, multiple approaches may be advantageously combined to produce conformal, essentially defect-free shells around individual particles. In some designs, shells may be deposited electrochemically.

In some designs, a suitable electrolyte may be a liquid electrolyte, a gel electrolyte, a solid electrolyte, or a hybrid electrolyte. In each case, such electrolytes should comprise alkali metal(s) and Al and enable sufficiently fast conduction of ions comprising alkali metals (e.g., Na⁺ in case of using pure Na-ion cathodes) and ions comprising aluminum metal (e.g., Al⁺, [AlCl₂]⁺, [AlCl₄]⁻, [Al₂Cl₇]⁻, [Al₃Cl₁₀]⁻, [Al₄Cl₁₃]⁻, etc.), where ions comprising alkali metals (e.g., Na⁺) are reversibly extracted from the cathode and added into the electrolyte during the cell charging (effectively replacing some of the Al in the electrolyte) and reversibly inserted back into the cathode during discharge, and where Al is at least partially displaced from the electrolyte and reversibly plated onto (or alloyed with) the anode electrode during charge and dissolved/extracted from the anode and re-inserted back into the electrolyte during discharge.

Multiple aspects may be considered when selecting the most appropriate electrolyte for the disclosed cell design. In some designs, the use of liquid electrolytes may facilitate higher conductivity at near-room or low temperatures. In some designs, the organic liquid electrolytes may be flammable and exhibit undesirably high vapor pressure, particularly at elevated temperatures, although these are most commonly used in alkaline-ion battery chemistries. In some designs, molten salts and ionic liquid (IL) electrolytes may offer significantly better safety (as these are not flammable), better thermal stability and low vapor pressure (particularly at elevated temperatures). Some ILs, however, may be prohibitively expensive for some applications (e.g., some grid energy storage applications). Herein, the term “molten salt” refers to a salt composition with a melting point of higher than about 100° C., and the term “ionic liquid” refers to a salt composition with a melting point of lower than about 100° C. In some designs, some molten salt electrolytes may be affordable and offer good thermal stability and cycle stability. Yet, some molten salt electrolytes may not offer sufficiently high oxidation stability and thus may not work with all the disclosed cathode materials. In some designs, polymer or gel electrolytes (e.g., based on organic solvents or ILs) may offer better safety relative to organic electrolytes, although polymer or gel electrolytes may somewhat suffer from reduced conductivity, reduced oxidation stability and, most undesirably, large volume fraction of polymer (or polymer and solvent) components that do not participate in the alkaline metal ion storage during charge. In some designs, aqueous (water-based or water-comprising) electrolytes (including both liquid and aqueous gel electrolytes) offer very high conductivity, good safety, the lack of toxicity, low-cost and other promising features. However, aqueous (water-based or water-comprising) electrolytes may not be compatible with some of the cathodes and typically additionally decompose (with hydrogen generation/hydrogen evolution) on the Al anode surface. As such, in some designs, very robust (in contact with both electrolyte and active material), conformal, ionically conductive (and, in the Al anode case, electronically insulating) protective coatings may need to be utilized between some of the electrode materials and aqueous (or water-containing) electrolytes, if water is present in the electrolyte. In some designs, some of such coatings may add complexity and cost to cell designs. Finally, in some designs, inorganic (or mixed organic-inorganic) solid-state electrolytes may be used. In some designs, some of these may be very affordable for most applications, are safe and their mechanical properties may additionally suppress formation of Al dendrites during cycling. In general, in some designs, the amount of solvent and polymer in the electrolyte may be kept to a minimum to reduce the required electrolyte volume because electrolyte is effectively used for alkaline ion storage. Excessive electrolyte volume may not only reduce specific and volumetric energy density of the disclosed cells, but also may increase its costs and reduce its performance. In this regard, in some designs, liquid electrolytes may preferably need to be highly concentrated (which may be called “super-concentrated” or, depending on the type of solvent used, “organic solvent(s)-in-salt” or “IL(s)-in-salt” or “water-in-salt”) or simply be based on molten salts (e.g., near eutectic composition) comprising aluminum and alkali metal ions. Overall, the specific choice of electrolyte may be governed by multiple design and application requirements' considerations as well as specific cathode materials used in cell construction. Various illustrative examples of suitable electrolytes of each class are described in the present disclosure, along with the key requirements and properties important for the various disclosed cell designs.

As previously mentioned, suitable electrolytes may comprise: (i) Al salt (e.g., aluminum halide(s), such as AlCl₃ in the simplest case of a pure chloride salt; or aluminum nitrate, such as Al(NO₃)₃) or combination of two or more Al salts, (ii) one, two, three or more salt(s) of alkali metals (e.g., salts of Na or K or Li or their various combinations, etc.; e.g., halide(s), such as NaCl, KCl, LiCl, in the simplest case of chloride salts or nitrates, such as NaNO₃, NaNO₂, KNO₃, KNO₂, LiNO₃, LiNO₂, etc.) and/or (iii) other (e.g., Al, K, Na, Li, Zn, Mg, Ca, Ba, Zn, Cu, Sr, Bi, Fe, Y, La, W, Mo and other suitable metal) salts (including, but not limited to chlorides, bromides, fluorides, nitrates, the salts of super-acids, such as imide salts, for example, NaFSI, CF₃SO₂N⁻(Na⁺)SO₂F, NaTFSI, CF₃CF₂SO₂N⁻(Na⁺)SO₂CF₃, CF₃CF₂SO₂N⁻(Na⁺)SO₂F, CF₃CF₂SO₂N⁻(Na⁺)SO₂CF₂CF₃, CF₃CF₂SO₂N⁻(Na⁺)SO₂CF₂CF₂CF₃, CF₃CF₂CF₂SO₂N⁻(Na⁺)SO₂CF₂CF₂CF₃, CF₃CF₂CF₂SO₂N⁻(Na⁺)SO₂CF₃, CF₃CF₂CF₂SO₂N⁻(Na⁺)SO₂F, C₄F₉SO₂N⁻(Na⁺)SO₂F, C₄F₉SO₂N⁻(Na⁺)SO₂CF₃, C₄F₉SO₂N⁻(Na⁺)SO₂C₂F₅, C₄F₉SO₂N⁻(Na⁺)SO₂C₃F₇, C₄F₉SO₂N⁻(Na⁺)SO₂C₄F₉, C₅F₁₁SO₂N⁻(Na⁺)SO₂F, C₅F₁₁SO₂N⁻(Na⁺)SO₂CF₃, C₅F₁₁SO₂N⁻(Na⁺)SO₂C₂F₅, C₅F₁₁SO₂N⁻(Na⁺)SO₂C₃F₇, C₅F₁₁SO₂N⁻(Na⁺)SO₂C₄F₉, C₅F₁₁SO₂N⁻(Na⁺)SO₂C₅F₁₁, CF₃SO₂N⁻(Na⁺)SO₂PhCF₃, and many others and their various in an illustrative example of Na⁺ salts; although analogous salts of K, Li and Al may similarly be employed in some designs) and/or (iv) small amount of suitable ILs or organic solvent(s) added to reduce melting (or glass transition) point and increase ionic conductivity of the electrolyte.

As used herein, if the melting (or glass transition) point of such an electrolyte is suppressed to the level where electrolyte becomes liquid at cell operating temperatures and conditions, such electrolyte may be characterized as “liquid electrolyte”. As used herein, if the melting (or glass transition) point of such an electrolyte is suppressed to the level where electrolyte becomes liquid at cell fabricating temperatures but remains solid at cell operating temperatures and conditions, such an electrolyte may be characterized as “solid electrolyte”.

Illustrative examples of suitable electrolyte may include, but are in no way limited to the following mixtures of salts (where each component of the salt present at above about 0.1 molar % is shown for illustrative purposes; with or without organic or IL solvent additives): NaCl—KCl—AlCl₃, NaCl—ZnCl₂—AlCl₃, NaCl—KCl—ZnCl₂—AlCl₃, KCl—ZnCl₂—AlCl₃, NaCl—KCl—LiCl—AlCl₃, NaCl—FeCl₃—AlCl₃, KCl—FeCl₃—AlCl₃, NaCl—KCl—FeCl₃—AlCl₃, NaCl—LiCl—FeCl₃—AlCl₃, KCl—LiCl—FeCl₃—AlCl₃, NaCl—KCl—LiCl—FeCl₃—AlCl₃, NaCl—LiCl—ZnCl₂—FeCl₃—AlCl₃, KCl—LiCl—ZnCl₂—FeCl₃—AlCl₃, NaCl—KCl—LiCl—ZnCl₂—FeCl₃—AlCl₃, NaCl—KCl—ZnCl₂—AlCl₃, NaCl—BaCl₂—AlCl₃, NaCl—KCl—BaCl₂—AlCl₃, KCl—BaCl₂—AlCl₃, NaCl—LiCl—BaCl₂—AlCl₃, NaCl—LiCl—BaCl₂—FeCl₃—AlCl₃, KCl—LiCl—BaCl₂—FeCl₃—AlCl₃, NaCl—KCl—LiCl—BaCl₂—FeCl₃—AlCl₃, NaCl—MgCl₂—BaCl₂—AlCl₃, NaCl—MgCl₂—AlCl₃, NaCl—ZnCl₂—MgCl₂—AlCl₃, NaCl—KCl—MgCl₂—AlCl₃, NaCl—KCl—MgCl₂—ZnCl₂—AlCl₃, KCl—MgCl₂—AlCl₃, KCl—MgCl₂—ZnCl₂—AlCl₃, NaCl—LiCl—MgCl₂—FeCl₃—AlCl₃, NaCl—LiCl—MgCl₂—ZnCl₂—FeCl₃—AlCl₃, KCl—LiCl—MgCl₂—FeCl₃—AlCl₃, KCl—LiCl—MgCl₂—ZnCl₂—FeCl₃—AlCl₃, NaCl—KCl—LiCl—MgCl₂—FeCl₃—AlCl₃, NaCl—KCl—LiCl—MgCl₂—ZnCl₂—FeCl₃—AlCl₃, NaCl—SrCl₂—AlCl₃, NaCl—SrCl₂—MgCl₂—AlCl₃, NaCl—ZnCl₂—SrCl₂—AlCl₃, NaCl—ZnCl₂— MgCl₂—SrCl₂—AlCl₃, NaCl—KCl—SrCl₂—AlCl₃, NaCl—KCl—SrCl₂—ZnCl₂—AlCl₃, KCl—SrCl₂—AlCl₃, KCl—SrCl₂—ZnCl₂—AlCl₃, NaCl—LiCl—SrCl₂—FeCl₃—AlCl₃, NaCl—LiCl—SrCl₂—ZnCl₂—FeCl₃—AlCl₃, KCl—LiCl—SrCl₂—FeCl₃—AlCl₃, KCl—LiCl—SrCl₂—ZnCl₂—FeCl₃—AlCl₃, NaCl—KCl—LiCl—SrCl₂—FeCl₃—AlCl₃, NaCl—KCl—LiCl—SrCl₂—ZnCl₂—FeCl₃—AlCl₃, NaCl—CuCl₂—AlCl₃, NaCl—CuCl₂—SrCl₂—AlCl₃, NaCl—CuCl₂—MgCl₂—AlCl₃, NaCl—ZnCl₂—CuCl₂—AlCl₃, NaCl—ZnCl₂—CuCl₂—SrCl₂—AlCl₃, NaCl—KCl—CuCl₂—AlCl₃, NaCl—KCl—CuCl₂—ZnCl₂—AlCl₃, KCl—CuCl₂—AlCl₃, KCl—CuCl₂—ZnCl₂—AlCl₃, NaCl—LiCl—CuCl₂—FeCl₃—AlCl₃, NaCl—LiCl—CuCl₂—ZnCl₂—FeCl₃—AlCl₃, KCl—LiCl—CuCl₂—FeCl₃—AlCl₃, KCl—LiCl—CuCl₂—ZnCl₂—FeCl₃—AlCl₃, NaCl—KCl—LiCl—CuCl₂—FeCl₃—AlCl₃, NaCl—KCl—LiCl—CuCl₂—ZnCl₂—FeCl₃—AlCl₃, NaCl—CaCl₂—AlCl₃, NaCl—CaCl₂—CuCl₂—AlCl₃, NaCl—CaCl₂—SrCl₂—AlCl₃, NaCl—CaCl₂—CuCl₂—SrCl₂—AlCl₃, NaCl—CaCl₂—MgCl₂—AlCl₃, NaCl—CaCl₂—CuCl₂—MgCl₂—AlCl₃, NaCl—ZnCl₂—CaCl₂—AlCl₃, NaCl—ZnCl₂—CaCl₂—CuCl₂—AlCl₃, NaCl—ZnCl₂—CaCl₂—SrCl₂—AlCl₃, NaCl—KCl—CaCl₂—AlCl₃, NaCl—KCl—CaCl₂—ZnCl₂—AlCl₃, KCl—CaCl₂—AlCl₃, KCl—CaCl₂—ZnCl₂—AlCl₃, NaCl—LiCl—CaCl₂—FeCl₃—AlCl₃, NaCl—LiCl—CaCl₂—ZnCl₂—FeCl₃—AlCl₃, KCl—LiCl—CaCl₂—FeCl₃—AlCl₃, KCl—LiCl—CaCl₂—ZnCl₂—FeCl₃—AlCl₃, NaCl—KCl—LiCl—CaCl₂—FeCl₃—AlCl₃, NaCl—KCl—LiCl—CaCl₂—ZnCl₂—FeCl₃—AlCl₃, NaCl—ZnCl₂—MgCl₂—BaCl₂—AlCl₃, NaCl—KCl—MgCl₂—BaCl₂—AlCl₃, NaCl—KCl—MgCl₂—ZnCl₂—BaCl₂—AlCl₃, KCl—MgCl₂—BaCl₂—AlCl₃, KCl—MgCl₂—ZnCl₂—BaCl₂—AlCl₃, NaCl—LiCl—MgCl₂—BaCl₂—FeCl₃—AlCl₃, NaCl—LiCl—MgCl₂—ZnCl₂—BaCl₂—FeCl₃—AlCl₃, KCl—LiCl—MgCl₂—BaCl₂—FeCl₃—AlCl₃, KCl—LiCl—MgCl₂—ZnCl₂—BaCl₂—FeCl₃—AlCl₃, NaCl—KCl—LiCl—MgCl₂—BaCl₂—FeCl₃—AlCl₃, NaCl—KCl—LiCl—MgCl₂—ZnCl₂—BaCl₂—FeCl₃—AlCl₃, KNO₃—NaNO₃—Al(NO₃)₃, KNO₃—NaNO₃—NaNO₂—Al(NO₃)₃, NaCl—NaTFSI—AlCl₃, NaCl—NaTFSI—FeCl₃—AlCl₃, KCl—KTFSI—AlCl₃, KCl—NaCl—NaTFSI—AlCl₃, LiCl—LiTFSI—AlCl₃, KCl—LiCl—LiTFSI—AlCl₃, NaCl—LiCl—LiTFSI—AlCl₃, KCl—NaCl—NaTFSI—KTFSI—AlCl₃, KCl—NaCl—LiCl—NaTFSI—KTFSI—AlCl₃, KCl—NaCl—LiCl—NaTFSI—KTFSI—LiTFSI—AlCl₃, and their various mixtures and combinations, to name a few examples. Note that some Cl in such examples may be at least partially replaced with Br or I to improve cell performance characteristics.

Illustrative examples of suitable compounds to form ionic liquids (ILs) for use with the disclosed electrolyte composition may include, but are in no way limited to the following IL-forming compounds: 1-ethyl-3-methylimidazolium chloride [(C₆H₁₁N₂Cl)], 1-ethyl-3-methylimidazolium bromide [(C₆H₁₁N₂Br)], 1-ethyl-3-methylimidazolium fluoride [(C₆H₁₁N₂F)], 1-butyl-3-methylimidazolium chloride [(C₈H₁₅N₂Cl)], 1-butyl-3-methyl pyridinium chloride [(C₁₀H₁₆NCl)], 1-butyl-1-methyl pyrrolidinium chloride [(C₉H₂₀NCl)], 1-benzyl-3-methylimidazolium chloride [(C₁₁H₁₃N₂Cl)], 1,3-dibenzyl-imidazolium chloride [(C₁₇H₁₇N₂Cl)], trimethyl phenyl ammonium chloride [(CH₃)₃N(Cl)C₆H₅)], 1-methyl-3-butylimidazolium chloride [(C₈H₁₆N₂Cl)], 1-ethyl-3-methyl imidazolium bis(trifluoro methyl sulfonyl) imide [(C₈H₁₁F₆N₃O₄S₂)], 1-butyl-3-methyl imidazolium bis(trifluoro methyl sulfonyl) imide [(C₁₀H₁₅F₆N₃O₄S₂)], 1-propyl-1-methyl pyrrolidinium bis(trifluoro methyl sulfonyl) imide [(C₁₀H₁₈F₆N₂O₄S₂)], 1-butyl-3-methyl pyridinium bis(trifluoro methyl sulfonyl) imide [(C₁₂H₁₆F₆N₂O₄S₂)], 1-butyl-1-methyl pyrrolidine bis(trifluoro methyl sulfonyl) imide [(C₁₁H₂₀F₆N₂O₄S₂)], 1-hexyl-3-methyl imidazolium bis(trifluoro methyl sulfonyl) imide [(C₁₂H₁₉F₆N₃O₄S₂)], 1-hexyl 2,3-dimethyl imidazolium bis(trifluoro methyl sulfonyl) imide [(C₁₃H₂₁F₆N₂O₄S₂)], 1-hexyl pyridinium bis(trifluoro methyl sulfonyl)imide [(C₁₃H₁₈F₆N₂O₄S₂)], 1-hexyl-3-methyl pyridinium bis(trifluoro methyl sulfonyl)imide [(C₁₄H₂₀F₆N₂O₄S₂)], 1-hexyl-3,5 dimethyl pyridinium bis(trifluoro methyl sulfonyl) imide [(C₁₅H₂₂F₆N₂O₄S₂)], 1-hexyl-1-methyl pyrrolidinium bis(trifluoro methyl sulfonyl) imide [(C₁₃H₂₂F₆N₂O₄S₂)], 1-hexyl-1-methyl pyrrolidinium bis(trifluoro methyl sulfonyl) imide [(C₁₃H₂₂F₆N₂O₄S₂)], 1-octyl-3-methylimidazolium bis(trifluoromethyl sulfonyl) imide [(C₁₄H₂₃F₆N₃O₄S₂)], trihexyl-tetradecyl phosphonium bis(trifluoromethyl sulfonyl)imide [C₃₄H₆₈F₆NO₄PS₂], 1-ethyl-3-methyl imidazolium hexa fluorophosphate [(C₆H₁₁F₆N₂P)], 1-butyl-3-methyl imidazolium hexa fluorophosphate [(C₈H₁₅F₆N₂P)], 1-hexyl-3-methyl imidazolium hexa fluorophosphate [(C₁₀H₁₉F₆N₂P)], 1-octyl-3-methyl imidazolium hexa fluorophosphate [(C₁₂H₂₃F₆N₂P)], 1-ethyl-3-methyl imidazolium tetrafluoroborate [(C₆H₁₁F₄N₂B)], 1-butyl-3-methyl imidazolium tetrafluoroborate [(C₈H₁₅F₄N₂B)], 1-hexyl-3-methyl imidazolium tetrafluoroborate [(C₁₀H₁₉F₄N₂B)], 1-octyl-3-methyl imidazolium tetrafluoroborate [(C₁₂H₂₃F₄N₂B)], 1-ethyl-3-methyl imidazolium trifluoro methane sulfonate [(C₇H₁₁F₃N₂O₃S)], 1-butyl-3-methyl imidazolium trifluoro methane sulfonate [(C₉H₁₅F₃N₂O₃S)], 1-hexyl-3-methyl imidazolium trifluoro methane sulfonate [(C₁₁H₁₉F₃N₂O₃S)], 1-hexyl-3-methyl imidazolium trifluoro methane sulfonate [(C₁₁H₁₉F₃N₂O₃S)], choline chloride:urea [(C₅H₁₄ClNO) (CH₄N₂₀)], choline chloride:ethylene glycol [(C₅H₁₄ClNO) (C₂H₆O₂)], and their various mixtures and combinations, to provide a few illustrative examples.

Illustrative examples of suitable organic solvents for use with the disclosed electrolyte composition may include, but are in no way limited to the following organic solvents: various linear and cyclic carbonates, including branched ones (such as, dimethyl carbonate, ethyl methyl carbonate, diethyl carbonate, dimethyl carbonate, propylene carbonate, vinylene carbonate, ethylene carbonate, 4-ethyl-1,3-dioxolan-2-one, 4,5-dimethyl-1,3-dioxolan-2-one, 4,4-dimethyl-1,3-dioxolan-2-one, 4-propyl-1,3-dioxolan-2-one, ethyl isopropyl carbonate, ethyl isobutyl carbonate, tert-butyl ethyl carbonate, among others, to name a few), various esters (including but not limited to linear and cycling esters, including branched ones, such as, ethyl propionate, ethyl isobutyrate, ethyl isovalerate, 2,2,2-trifluoroethyl isobutyrate, 2-cyanoethyl isobutyrate, 2,5-dicyanopentyl isobutyrate, 2-(2,2-dioxido-3H-1,2-oxathiol-4-yl)ethyl isobutyrate, 4-(methylsulfonyl)benzyl isobutyrate, 2-((difluorophosphoryl)oxy)ethyl isobutyrate, 2-((1,3,2-dioxaphospholan-2-yl)oxy)ethyl isobutyrate, 2-((trimethoxysilyl)oxy)ethyl isobutyrate, 2-(azidomethoxy)ethyl pivalate, allyl isobutyrate, but-2-yn-1-yl propanoate, N-(2,2,2-trifluoroethyl)isobutyramide, N-(2-cyanoethyl)isobutyramide, N-(2,5-dicyanopentyl)isobutyramide, 2-(2,2-dioxido-3H-1,2-oxathiol-4-yl)ethyl 2-methylpropanedithioate, O-(4-(methylsulfonyl)benzyl) 2-methylpropanethioate, S-(2-((difluorophosphoryl)oxy)ethyl) 2-methylpropanethioate, S-(2-((1,3,2-dioxaphospholan-2-yl)oxy)ethyl) 2-methylpropanethioate, trimethyl (2-propionamidoethyl) silicate, N-(2-(azidomethoxy)ethyl)isobutyramide, S-allyl 2,2-dimethylpropanethioate, N-(but-2-yn-1-yl)isobutyramide, to name a few), various ethers (such as, dipropyl ether, butyl ethyl ether, 1-propoxybutane, ethyl pentyl ether, to name a few), various sulfur-comprising solvents (such as, cyclic sulfones such as tetramethylene sulfone (also called sulfolane), 1,3,2-dioxathiolane-2,2-dioxide, methylene methanedisulfonate, tris(trimethylsilyl) phosphite, trimethylene sulfate, terthiophene, sulfonyldiimidazole, ethylene sulfite, phenyl vinyl sulfone and others; cyclic sulfonic esters such as propane sultone, propene sultone, phenyl vinyl sultone, and others; linear sulfonic esters, linear sulfones such as dimethyl sulfone, ethylmethyl sulfone and others; sulfoxides, etc., to name a few), various nitriles, nitroalkanes and other nitrogen-comprising solvents (such as, for example, adiponitrile, propionitrile, butyronitrile, 1,2,3-tris(2-cyanoethoxy)propane, 1,3,5-pentanetricarbonitrile, 1,2,3-propanetricarbonitrile, tris(2-cyanoethyl)borate, 1,3,6-hexanetricarbonitrile, pentaerythritol tetranitrate, dimethylacetamide, ethylene glycol bis(propionitrile)ether, fumaronitrile, succinonitrile, glutaronitrile, adiponitrile, p-toluenesulfonyl isocyanate, 1,1′-sulfonyldiimidazole, 1,3,6-hexanetricarbonitrile, pyridine boron trifluoride, 3-fluoro pyridine boron trifluoride, pyrazine boron trifluoride, to name a few), various sulfoxides (such as, dimethyl sulfoxide, dimethyl sulfite, sulfolane, to name a few), various ketones (such as, ethyl methyl ketone, isobutyl methyl ketone, diethyl ketone, diisopropyl ketone, pinacolone, hexamethyl acetone, cyclohexanone, cyclopentanone, and cyclobutanone, nitromethane, nitroethane, to name a few), various phosphates and other phosphorus-containing compounds (such as, tributyl phosphate, tri-o-cresyl phosphate, triethyl phosphate, trimethyl phosphate, triphenyl phosphate, to name a few), various alkanes (such as, n-heptane or triptane, to name a few), various siloxanes (such as, hexamethyldisiloxane or octamethyltrisiloxane, to name a few), various silanes (such as, diphenyl silane, for example), various ureas (such as, tetramethylurea, for example), various borates (such as, triethyl borate, triisopropyl borate or tri-tert-butyl borate, to name a few), among others and their various combinations, to provide a few illustrative examples.

Note that depending on (i) the fraction of the organic solvent in the electrolyte and (ii) the electrolyte filling temperature and (iii) chemistry of electrodes and cell operating conditions, it may be advantageous for the solvents to exhibit a relatively high boiling point (e.g., above that of the cell operating temperature or, in some designs, above the electrolyte infiltration or cell fabrication temperature). In some implementations, the weight fraction of organic solvents in the electrolyte is less than about 10 wt. % (e.g., less than about 10 wt. %, or less than about 8 wt. %, or less than about 5 wt. %, or less than about 2 wt. %, or less than about 1 wt. %, or less than about 0.1 wt. %). The larger the fraction of the solvent and the higher the cell operation or electrolyte filling temperature is, the more advantageous it may be to utilize solvents of higher boiling points. For example, in some designs, for the cell typically operating at, say, 60° C., the same cell being filled with the electrolyte at, say, 100° C. and the same cell comprising, say, 10 vol. % (or about 10 wt. %) of a solvent in its electrolyte, it may be advantageous for the solvent boiling point to exceed around 100-120° C. In the meantime, for example, in some other designs, for the cell typically operating at, say, 60° C., the same cell being filled with the electrolyte at, say, 100° C. and the same cell comprising, say, 0.1 vol. % (or about 0.1 wt. %) of solvent in its electrolyte, it may be acceptable for the solvent boiling point to exceed around, say, 80-100° C. Also note that the specific solvent or combination of solvents for the addition to electrolyte may need to be carefully selected and optimized (i) to improve stability and resistance contributions of the interphases with electrodes (at operating temperature range or specific conditions) or (ii) to improve electrolyte conductivity or (iii) to reduce the melting or glass transition temperature/softening point of the electrolyte or (iv) to provide other specific performance or fabrication advantages. The optimal solvent selection depends on the particular electrolyte, anode and cathode chemistry and surface chemistry, maximum cell voltage and may even depend on the electrode surface area and morphology as well as the cell dimensions, current collectors used, cell shape and other factors.

In some designs, a suitable disclosed electrolyte may comprise a solid component or be 100% solid during all or part of the battery cell operation (e.g., at least a portion of cell charging and/or cell discharging).

In some designs, suitable solid electrolytes in accordance with embodiments of the present disclosure may comprise inorganic alkali metal-containing and halide-containing salts. In some designs, such solid electrolytes may comprise Na metal halides, where at least one, but often preferably two, three, four or more different non-Na metals and one, two or more different halogens (Cl, F, Br, etc.) may be advantageously utilized, and wherein all such elements (Na, two or more non-Na metal(s), one or more halides) are present in the excess of about 0.05 at. %. Examples of suitable non-Na metals for the solid electrolyte compositions may include, but are not limited to: H, B, Mg, Al, K, Li, Ca, Sc, Sr, Zn, Ga, Sr, Y, Zr, Nb, W, Mo, Cd, In, Sn, Sb, Cs, Ba, La, Ce, Cu, Fe, Hf, Ta, and Bi. In some designs, the fraction of Na (as % of all elements in the solid electrolyte) may range from around 1.0 at. % to around 40.0 at. % (as % of all elements in the electrolyte composition). In some designs, the fraction of K may range from around 1 at. % to around 40 at. % (as % of all elements in the electrolyte composition). In some designs, the fraction of Al may range from around 1.0 at. % to around 20.0 at. % (as % of all elements in the electrolyte composition). In some designs, the fraction of Cl may range from around 10.0 at. % to around 70.0 at. % (as % of all elements in the electrolyte composition). In some designs, the fraction of Br may range from around 0.1 at. % to around 25 at. % (as % of all elements in the electrolyte composition). In some designs, the fraction of I may range from around 0.01 at. % to around 10 at. % (as % of all elements in the electrolyte composition). In some designs, both Br and Cl may be advantageously present in the electrolyte. In some designs, both I and Cl may be advantageously present in the electrolyte. In some designs, the fraction of Mg may range from around 0.01 at. % to around 10.0 at. % (as % of all elements in the electrolyte composition). In some designs, the fraction of Ca may range from around 0.01 at. % to around 10.0 at. % (as % of all elements in the electrolyte composition). In some designs, the fraction of Zn may range from around 0.01 at. % to around 10.0 at. % (as % of all elements in the electrolyte composition). In some designs, the fraction of Sr may range from around 0.01 at. % to around 10.0 at. % (as % of all elements in the electrolyte composition).

In some designs, halide-containing solid electrolytes with suitable (in accordance with one or more embodiments of the present disclosure) thermal, mechanical, microstructural, ionic conductivity and other properties may additionally comprise oxygen (O). In some designs, the fraction of 0 may range from around 0.01 at. % to around 20.0 at. % (as % of all elements in the electrolyte composition).

In some designs, halide-containing solid electrolytes with suitable (in accordance with one or more embodiments of the present disclosure) thermal, mechanical, microstructural, ionic conductivity and other properties may additionally comprise sulfur (S). In some designs, the fraction of S may range from around 0.01 at. % to around 20.0 at. % (as % of all elements in the electrolyte composition).

In some designs, halide-containing solid electrolytes with suitable (in accordance with one or more embodiments of the present disclosure) thermal, mechanical, microstructural, ionic conductivity and other properties may additionally comprise nitrogen (N). In some designs, the fraction of N may range from around 0.01 at. % to around 20.0 at. % (as % of all elements in the electrolyte composition).

In some designs, solid electrolytes with suitable (in accordance with one or more embodiments of the present disclosure) thermal, mechanical, microstructural, ionic conductivity and other properties may comprise small amounts (e.g., from around 0.01 wt. % to around 20.0 wt. %; in some designs from around 0.1 wt. % to around 10.0 wt. %; in yet some designs, from around 0.2 wt. % to around 6 wt. %) of inorganic or organic dopants, which may be added to reduce a melting point or improve conductivity or increase ductility or improve wetting to the electrode or form more favorable anode solid electrolyte interphase (SEI)/cathode solid electrolyte interphase (CEI) or tune other solid electrolyte properties for improved cell assembling or cell operation.

Examples of inorganic dopants may include, but are not limited to: SO₂, SO₂Cl₂, POC₃, P₂S₅, N₂O₄, SbCl₃, BrF₅, among others. Examples of organic dopants may include various ILs, carbonates, ethers, esters, ketones, sulfones and other S-comprising solvents, phosphates and other P-comprising solvents, borates, nitriles and other N-comprising solvents, and various other suitable solvents (including those previously used in Li, Li-ion, Na, Na-ion, K, and K-ion, Al and Al-ion battery applications).

In some designs, suitable electrolyte may comprise two, three, four or more distinctly different components, such as organic salt(s), inorganic salt(s), ionic liquid(s), organic solvent(s), monomer(s), polymer(s), among others. As used herein, such electrolytes may be characterized as “hybrid” electrolytes. In some designs, hybrid electrolytes may be solid. In some designs, hybrid solid electrolytes may comprise both inorganic solid electrolyte component and organic solid electrolyte. In some designs, hybrid electrolytes may comprise both solid and liquid fractions. In some designs, a solid fraction may be mostly inorganic. In some designs, a liquid fraction may be mostly organic or mostly inorganic.

In some designs, the selection of particular electrolyte compositions may depend on the particular electrode chemistry and the cell requirements (such as operational temperature range, voltage range, power performance, etc.), the presence of functional coating(s) on the surface of electrode particles, permissible costs, thermal stability of electrodes or cell components, and other parameters.

One important consideration in the disclosed battery cell design is the total volume fraction of electrolyte relative to the total volume of the cell or the volume occupied by the cathode active material. In some designs, it may be highly advantageous for the total volume fraction of electrolyte not to exceed the total volume fraction of the cathode material. In some design, the total volume of electrolyte may range from about 25 vol. % to about 100 vol. % of the total volume occupied by the cathode material (in some designs, from about 25 to about 40 vol. %; in other designs, from about 40 to about 60 vol. %; in other designs, from about 60 to about 80 vol. %; in yet other designs, from about 80 to about 100 vol. %. In some design, the total volume electrolyte may range from about 5 vol. % to about 40 vol. % of the total cell volume (in some designs, from about 5 to about 10 vol. %; in other designs, from about 10 to about 20 vol. %; in other designs, from about 20 to about 30 vol. %; in other designs, from about 30 to about 40 vol. %).

The most conventionally used separator membranes for commercial Li-ion battery electrodes typically comprise polymers, such as polypropylene or polyethylene, or both. In some cases, a porous ceramic layer is deposited on the surface of the separator membranes (typically at the cathode side) to reduce shrinkage at elevated temperatures and increase cycle life and safety. In some cases, a separator membrane is coated with a layer of a surfactant to increase wetting in some electrolytes. However, improved (different) separator design may be advantageously used in aspects of the present disclosure.

First, depending on the chemistry and the temperature of the electrolyte (e.g., during electrolyte infiltration), poor wetting on the polymer surface may be a serious issue that prevents successful and complete infiltration of electrolyte into the separator membrane or a separator layer. Many typically used surfactants are not sufficiently thermally or chemically stable and may evaporate or decompose during the electrolyte infiltration process, particularly if it is conducted at elevated temperatures. Second, mechanical properties of the polymer separator material may be compromised (particularly at higher temperatures). Third, a polymer separator membrane may undesirably start melting at elevated temperatures, inducing pore closure and shrinkage. For example, both polyethylene and polypropylene typically melt at temperatures as low as about 115-135° C. Fourth, many polymer separator membranes may decompose and induce formation of undesirable gaseous products at elevated electrolyte infiltration temperatures.

In some designs, porous ceramic membranes (e.g., porous oxide-based or porous hydroxide or porous oxyhydroxide or porous nitride-based membranes, among others) or porous ceramic-polymer composite membranes may be more suitable for some of the disclosed cell designs than conventional polymeric membranes. In some membrane designs, the use of a fibrous porous ceramic may be advantageous. Porous ceramic or porous ceramic-polymer composite membranes, comprising one, two or more of Al, Si, Mg, Zr, Si, Ti, Zn, Cu, and Fe, may be particularly advantageous as they may offer a combination of good electrochemical and thermal stabilities, which can be advantageous in accordance with one or more embodiments of the present disclosure.

In some designs, the separator may be a dense alkali metal-ion conductive membrane (e.g., dense haloaluminate or dense oxide-based or dense phosphate or dense thiophosphate or dense fluoride or dense nitride-based membranes, among others) or dense alkali-metal-ion conductive ceramic-epoxy composite membranes may be more suitable for some of the disclosed cell designs than conventional polymeric membranes. As used herein, a dense membrane is understood to mean a membrane that is non-porous or a membrane that is not highly porous, such that it is ionically conductive but exhibits low permeability to gas and liquid. Dense ceramic or dense ceramic-epoxy composite membranes comprising one, two or more of Al, Si, Ge, Mg, Zr, Si, Ti, Zn, Zr, Cu and Fe, and has a structure such as olivine, NASICON, or perovskite may be particularly advantageous as such materials and structures may offer a combination of good electrochemical, thermal stabilities, and ionic conductivity, which can be advantageous in accordance with one or more embodiments of the present disclosure.

In some designs, the separator membrane layer(s) may advantageously comprise elongated particles (such as nanowires, whiskers, nanofibers, nanotubes, flakes, etc.) with aspect ratios above about 3 (preferably above about 10 and even more preferably above about 30) (preferably, the aspect ratios are below about 1×10⁶ or below about 1×10⁵) and the average smallest dimensions (e.g., diameter or thickness) below about 1000 nm—in some designs, from about 1 nm to about 10 nm; in other designs, from about 10 nm to about 100 nm; in yet other designs, from about 100 nm to about 1000 nm). In some designs, elongated (in two or preferably in one dimension) particles may be used to achieve high porosity of the membrane and thus increase its ionic conductivity when fully filled with the electrolyte.

In some designs (e.g., to improve wetting by a solid electrolyte or a solid electrolyte melt, or to improve thermal, mechanical, or electrochemical stability) polymer-ceramic composite membranes may comprise ceramic particles or ceramic coating(s). In some designs, the suitable dimensions of such ceramic particles may generally range from around 2 nm to around 5 microns, depending on the cell design. In some designs, the weight fraction of such ceramic particles in the polymer-ceramic composites may range from around 0.02 wt. % to around 99 wt. %.

In some designs, a separator (or at least a component of the separator) may be prepared as a standalone (e.g., porous) membrane. In other designs, a separator (or at least a component of the separator) may be deposited onto the surface of one or both electrodes or on the surface of the anode current collector.

In some designs, the anode may comprise an aluminum metal in a morphology of planar foil, nano- or micro-textured foil, elongated fiber mesh, or highly porous foam. In other designs the anode elemental composition may comprise other transition or alkali metals such as Be, Cr, Cu, Fe, Ni, Li, Na, K, Mn, Mg, Mo, W, Ti, Zn, Zr, Ga and Bi, non-metals such as Si, Ge, Sn, Bi, and Sb, or alloy combination of these elements, with or without Al. In designs where the anode does not contain aluminum and the electrolyte does contain aluminum ions, the cells will operate in an “anode-less” configuration where the current collector will serve as a pseudo-anode providing a surface to lower plating overpotentials or purposely increase anode half-reaction voltage and or capacity.

In some designs, the use of conductive carbon (e.g., carbon nanofibers, carbon whiskers, carbon nanotubes (such as single-walled, double-walled, and multi-walled carbon nanotubes), graphene, multilayered graphene, exfoliated graphite, graphite flakes, amorphous carbon, carbon black, various dendritic carbons and their mixtures and composites, etc., and other forms of conductive carbon), nickel (or nickel alloy), steel, zirconium (or zirconium alloy), zinc (or zinc alloy) or titanium (or titanium alloy) based (or comprising) current anode or cathode collectors may be advantageous in some designs due to their improved compatibility with some of the electrolytes.

In some designs, Al or Al-alloy current collectors for the anode or the cathode may comprise a layer of a protective surface coating (preferably from around 1 nm to around 1 micron in average thickness). In some designs, such a protective layer may comprise: Ni, Ti, Fe, Zn, Zr, Al, W, Nb, Na, K, Li, carbon, or carbon composite (e.g., carbon-ceramic or carbon-polymer composite, where a polymer is preferably sufficiently thermally stable to withstand melt infiltration with electrolyte (note that selected examples of suitable polymers are provided above in relation to the discussion of the polymer binder materials and polymer separator membranes) or (e.g., conductive) metal oxide(s) or carbide(s). In some designs, the carbon in the protective layer may comprise amorphous or disordered (turbostratic) carbon, graphitic carbon or carbon particles and nanoparticles of various shapes, size, and aspect ratios (e.g., carbon onions, carbon blacks, branched carbons, carbon nanofibers, carbon whiskers, carbon nanotubes (such as single-walled, double-walled and multi-walled carbon nanotubes), graphene, multilayered graphene, exfoliated graphite, graphite flakes, or porous carbons, etc.). Depending on the composition of the protective layer and current collector, this protective layer in some designs may be formed by using a spray-coating process, by a slurry-based deposition process, by an electrochemical or electrodeposition process, by electrophoretic deposition, by a vapor-phase deposition (e.g., by CVD, ALD, etc.), by layer-by-layer deposition, by a sol-gel deposition, by a precipitation, or by using other suitable processes and their combinations.

Another suitable function of the coating on the current collector in some designs is to reduce the thermal stresses at the current collector/electrode interface. For example, metals typically exhibit higher thermal expansion than ceramic materials. As such, metal foil current collectors will typically compress more during cooling from the melt-infiltration temperatures. In some designs, the use of a surface coating may reduce the stress concentration and improve stability of these solid electrolyte cells. Coatings comprising thermally stable polymers or carbon may be advantageous for this purpose in some designs. Furthermore, the presence of pores in such a coating may further assist in stress accommodation in some designs. In some designs, a suitable porosity of the coating may range from around 0.1 vol. % to around 30 vol. %.

As previously disclosed, the use of solid electrolytes may prove to be particularly advantageous in some designs. Furthermore, certain techniques to incorporate solid electrolyte into the cells may be advantageous in some designs.

One aspect of the present disclosure involves melt-infiltration (as opposed to mixing and/or sintering) of the solid-state electrolytes (SSEs) into sufficiently thermally stable electrodes (or into the cathode/separator/anode/separator/stacks or rolls or into dry assembled cells) at elevated temperatures when the SSE is in a liquid (e.g., molten) phase. In this case a high-volume fraction (e.g., about 65-90 vol. %) of the active material in the electrodes with SSE may be achieved.

Similarly, a thin SSE membrane (or SSE-based composite membranes comprising separators) may be fabricated (e.g., from around 0.5 to around 30 microns) either as a surface layer on the top of the electrode (or anode current collector) or as a composite produced by infiltrating a sufficiently thermally stable porous layer (porous membrane). In some designs, such a sufficiently thermally stable porous layer may be deposited on the electrode (or current collector) surface prior to electrolyte infiltration. In some designs, the porous membrane may comprise more than one layer. In some designs, at least one layer of such a membrane may be electrically insulative to reduce or prevent electron conduction through the composite SSE (e.g., produced by infiltration into the membrane) to prevent or significantly reduce self-discharge of a cell. In some designs, different layers of the porous membrane (separator) may comprise (interconnected) particles of different size, different shape, exhibiting different porosity, having different composition, etc. In some designs, it may be advantageous for the center of the membrane to comprise larger particles (including larger elongated particles, larger (nano)fibers or larger (nano)wires or larger (nano)flakes, etc.) and/or larger pores to provide enhanced mechanical stability and improved performance.

When optimizing the composition and properties of the solid-state in accordance with one or more embodiments of the disclosure, one or more of the following properties may be carefully considered: (i) achieving good wetting on electrode surfaces; (ii) achieving low charge-transfer resistance at the electrolyte/active material interphase at the electrode surface; (iii) achieving chemical compatibility with the electrode materials of choice (e.g., lack of undesirable chemical reactions, instabilities in the cathode solid electrolyte interphase (CEI) and anode solid electrolyte interphase (SEI) properties, etc.) at all states of charge or discharge at both the operating temperatures and, ideally, melt-infiltrating temperatures; (iv) sufficient chemical stability of the current collector(s) (or at least their surfaces) during interactions with the electrolyte, particularly at higher temperatures during melt-infiltration or operation; (v) broad potential range of experimentally observed electrochemical stability in cells; (vi) high grain boundary conductivity of the SSEs, which may allow one to achieve high rate performance in nanostructured electrodes; (vii) high ionic conductivity; (viii) improved resistance to dendrite (e.g., Al dendrite) penetration during cycling in cells, among many others; and/or (ix) resistance of the SSE cells to cracking under abuse conditions (high fracture toughness).

In some designs, active materials may experience substantial volume changes during the first cycle (sometimes as large as about 140 vol. %). To better accommodate these large volume changes during the first (or the first few) cycle(s) in cells comprising SSEs, in some designs, it may be advantageous in some designs to conduct these cycle(s) at an elevated temperature where the solid electrolyte is either soft (e.g., above the glass transition temperature of the SSE) or molten (e.g., above the melting temperature of the SSE). In this case, a sufficiently high ionic conductivity of the solid electrolyte in a molten state may be particularly advantageous.

In some designs, the advantageous use of melt-infiltration or melt-impregnation of the suitable SSE electrolyte(s) at elevated temperatures (when electrolyte is liquid and exhibit sufficiently low viscosity) into a sufficiently thermally stable (e.g., to avoid/reduce possibly undesirable degradation during the infiltration/impregnation procedure) separator and/or sufficiently thermally stable (to avoid/reduce possibly undesirable degradation during the infiltration/impregnation procedure) electrode(s) or both may benefit from suitable composition and properties of both the SSE and other solid state battery components (which may depend on the selected SSE) and suitable techniques of cell assembling and cell architecture. In other words, certain properties of the electrode and SSE electrolyte as well as certain composition and microstructure of the electrode and electrolyte may be important for such cells to perform particularly well. One or more aspects of the present disclosure provides an explanation of at least some of such properties, composition, and microstructures as well as synthesis and processing routes to achieve higher performance via an intelligent pairing of electrode/SSE/electrolyte compositions and fabrication techniques for melt-infiltration solutions. In some designs, it may be particularly advantageous to attain a combination of such properties, composition, and microstructures in a single cell design for optimal performance.

A desirable characteristic of SSEs in some designs in accordance with one or more embodiments of the present disclosure is a low melting temperature. Such a property is commonly ignored in traditional solid electrolytes and solid-state cell designs. For example, the melting point of common oxide-based solid electrolytes (e.g., very popular garnet electrolytes) may exceed 1100° C. However, higher processing temperatures may make solid electrolyte cells impractical for most applications. In some designs, it may be advantageous for the electrolyte melting point to be in the range from around 40.0° C. to around 300.0° C. (in some designs, from around 40.0° C. to around 100.0° C.; in other designs, from around 100.0° C. to around 150.0° C.; in yet other designs, from around 150.0° C. to around 200.0° C.; in yet other designs, from around 200.0° C. to around 250.0° C., in yet other designs, from around 250.0° C. to around 300.0° C., depending on the cell composition, cell operation conditions, electrode loading, mismatch between the thermal expansion coefficients of various electrode/cell components including that of the solid electrolyte, ionic conductivity of the electrolyte at cell operating temperatures, current collectors composition, surface properties and their reactivity with the solid electrolyte as a function of temperature, binder composition and surface properties, among other factors).

Another important property of solid electrolytes in some designs in accordance with one or more embodiments of the present disclosure is viscosity above the glass transition temperature and above the melting temperature. In some designs, it may be advantageous for the electrolyte viscosity during the melt infiltration (melt-impregnation) procedure to range from around 0.2 cP (centipoise) to around 20,000 cP (in some designs, from about 0.2 cP to about 100 cP; in other designs, from about 100 cP to about 1,000 cP; in yet other designs from about 1,000 cP to about 5,000 cP; in yet other designs from about 5,000 cP to about 20,000 cP). In some designs (depending on the cell configuration, relative reactivity of components, relative thermal expansion coefficient of components, electrolyte wetting properties and/or other factors), it may be advantageous for the electrolyte viscosity at about 50° C. above the melting point (or liquidus temperature) to range from around 1 cP to around 20,000 cP. In some designs, too high viscosity of the molten solid electrolyte may make the cell and electrode fabrication process inefficient, imperfect, expensive and/or result in poor cell performance.

In some designs, it may be further important that components of solid electrolytes do not have the tendency to preferentially evaporate during melting (e.g., do not exhibit partial vapor pressure above about 0.05 atm at or near the melt-infiltration temperature).

In some designs, solid electrolytes in accordance with embodiments of the present disclosure may exhibit a moderate density in the range from around 0.60 g/cm³ to around 3.00 g/cm³ (in some designs, from around 0.60 g/cm³ to around 1.20 g/cm³; in other designs, from around 1.20 g/cm³ to around 2.00 g/cm³; in yet other designs, from around 2.00 g/cm³ to around 2.50 g/cm³; in yet other designs, from around 2.50 g/cm³ to around 3.00 g/cm³). In some designs, too high density may lead to undesirably low specific energy and undesirably low specific power at the cell level. In addition, in some designs, too high density may also correlate with the presence of substantial content of heavy elements in the composition that may also lead to undesirable performance characteristics or undesirable other factors for the solid electrolyte composing cells, such as higher toxicity, cost, production yield, etc. Too high (e.g., above about 3.0 g/cm³) solid electrolyte densities (or even too low) may also be associated with the formation of the undesirable properties of the interface or interphase between active electrode material and the solid electrolyte.

In some designs, solid electrolytes in accordance with embodiments of the present disclosure may exhibit moderate values of the thermal expansion coefficient in order to produce cells with high yield and robust microstructure. Stresses induced in the electrodes or the cells during cooling from melt-infiltration temperatures may induce cell failure during the battery operation, particularly if cells may be subjected to additional stresses (e.g., if the cells are dropped or hit or subjected to additional stresses during cycling or handling, etc.). In some designs, the optimal value of the thermal expansion coefficient may depend on multiple factors, including electrode density, electrode thickness, melt-infiltration temperature, cell operation, composition of the active material and the electrodes, among others. However, suitable values for the volumetric thermal expansion coefficient (at atmospheric pressure and room temperature) may generally be in the range from about 8·10⁻⁷ K⁻¹ to about 8·10⁻³ K⁻¹ in some designs. In some designs, total thermal shrinkage of the electrolyte from the highest temperatures electrodes and cells are exposed to (e.g., during melt infiltration) to the lowest temperature (e.g., during operation or storage in cold climates or cold storage room) may preferably be in the range from about 0.001 vol. % to about 20.00 vol. % (in some designs, from around 0.01 vol. % to around 5.0 vol. %).

In some designs, solid electrolytes in accordance with embodiments of the present disclosure may exhibit moderate ductility at the operational temperatures (or storage temperatures, in some design). In some designs, the minimum value of the sustainable strain or ductility depends on multiple factors, such as electrode and cell composition and thickness, stresses during operation, thermally-induced stresses and strain, cycling-induced stresses, porosity, distribution of the pores within the electrodes or other cell components, distribution of the pore sizes and strain among other factors. However, in some designs, a suitable range of the maximum compressive strain (at 60° C.) may generally be from about 0.1% to about 500.0% (in some designs, from around 1.0% to around 100.0%) and a suitable range of the maximum tensile strain (at 60° C.) may generally be from 0.1% to about 500% (in some designs, from around 1.0% to around 50.0%).

In some designs, solid electrolytes in accordance with embodiments of the present disclosure may exhibit moderate values of Young's modulus (at room temperature) in the range from about 0.1 GPa to about 100.0 GPa (in some designs, from about 0.1 GPa to about 20 GPa; in other designs, from about 20 GPa to about 100.0 GPa). In some designs, solid electrolytes in accordance with embodiments of the present disclosure may exhibit moderate values of Shear modulus (at room temperature) in the range from about 0.03 GPa to about 30.0 GPa (in some designs, from about 0.03 GPa to about 8 GPa; in other designs, from about 8 GPa to about 30.0 GPa). In some designs, solid electrolytes in accordance with embodiments of the present disclosure may exhibit moderate values of Vickers hardness (at room temperature) in the range from about 0.01 GPa to about 5.0 GPa (in some designs, from about 10 MPa to about 100 MPa; in other designs, from about 100 MPa to about 1 GPa; in yet other designs, from about 1 GPa to about 5 GPa). In some designs, too high or too low values for the modulus or hardness may lead to reduced stability or performance characteristics of solid electrolyte-based cells in accordance with embodiments of the present disclosure.

In some designs, solid electrolytes in accordance with embodiments of the present disclosure may exhibit small or moderate grain size at operational temperatures, particularly when infiltrated into electrodes (or separators). In some designs, small grain size in solid electrolyte may improve cell stability and performance and may reduce a probability of aluminum (Al) dendrites penetrating through the solid electrolyte. While the optimal grain size range may depend on the solid electrolyte composition, cell construction and many other features, suitable average grain size for some designs may range from about 0.0 nm (fully amorphous composition) to about 5000 nm (in some designs, from about 0.0 nm to about 200.0 nm; in other designs, from about 200.0 nm to about 2000.0 nm; in yet other designs, from about 2000 nm to about 5000 nm). In some designs, it may also be important for the solid electrolyte not to exhibit macroscopic defects (e.g., such as voids, cracks, etc.) in excess of around 10,000 nm³ in volume.

In some designs, solid electrolytes in accordance with embodiments of the present disclosure may exhibit relatively high conductivity between around 25° C. and 60° C. In particular, in some designs, the total ionic conductivity may range from around 5·10⁻⁴ S/cm to around 10⁻¹ S/cm at 60° C. (in some designs, alkali metal ion (e.g., Na⁺) transport-related portion of the ionic conductivity may range from around 5·10⁻⁴ S/cm to around 10⁻¹ S/cm at about 60° C.). In some designs, the ionic conductivity may preferably range from around 5·10⁻⁴ S/cm to around 10⁻¹ S/cm at 25° C. (in some designs, Na⁺ transport-related portion of the total ionic conductivity may range from around 10⁻⁴ S/cm to around 10⁻¹ S/cm at about 25° C.). In some designs, the alkali metal ion (e.g., Na⁺) transfer number of the solid electrolytes in accordance with embodiments of the present disclosure may preferably range from around 0.4 to around 1.0 in the temperature range where the solid electrolytes and cells comprising said solid electrolytes are operating.

In some cells, the use of vacuum (e.g., from around 400 Torr to around 0.0001 Torr pressure) may be advantageously used to assist the electrolyte infiltration process by overcoming some of the wetting issues (e.g., insufficiently good wetting or insufficiently low viscosity at the temperatures suitable for the melt infiltration and the formation of low resistance interfaces or interphases with the electrode or the current collector). In addition, in some designs, it may be advantageous to utilize hydrostatic pressure (e.g., from around 0.1 to around 10 atm. above the atmospheric pressure) to assist the electrolyte infiltration (e.g., insufficiently good wetting or insufficiently low viscosity at the temperatures suitable for melt infiltration, etc.).

In some designs, the electrolyte infiltration process may utilize a controlled atmosphere to reduce or prevent undesirable chemical reactions and/or to promote desired reactions and physical processes at different stages of the melt-infiltration process. Illustrative examples of such controlled atmospheres may include, but not limited to: (i) effectively water-free environment (e.g., where the water concentration is in the range from around 0.001 ppm to around 100.000 ppm) to reduce or prevent undesirable oxidation reactions and water absorptions; (ii) effectively oxygen-free environment (e.g., where the oxygen concentration is in the range from around 0.01 ppm to around 1000.00 ppm) to reduce or prevent undesirable reactions with oxygen; (iii) effectively nitrogen-free environment (e.g., where the nitrogen concentration is in the range from around 0.01 ppm to around 1000.00 ppm) to reduce or prevent undesirable nitridations reactions; (iv) vacuum (e.g., from around 0.0000001 Torr to around 100 Torr) to reduce or prevent undesirable reactions and also to remove undesirable chemicals such as water and other solvents (and/or, as previously described, to accelerate the infiltration process); (v) effectively hydrogen-free environment (e.g., where the nitrogen concentration is in the range from around 0.01 ppm to around 1000.00 ppm) to reduce or prevent undesirable hydrogenation reactions.

In some designs, heating the electrodes or pre-assembled cell components before, during or after the electrolyte infiltration may be performed by (i) electromagnetic radiation (e.g., infrared, microwave and/or by using other wavelengths), (ii) passive or active convection, (iii) by heat conduction via a direct contact with a hot body, (iv) by conduction of the electrical current through the electrically conductive components (e.g., current collector foils, etc.) and/or other suitable techniques.

In some designs (e.g., when the battery is made by stacking the electrodes/separators) it may be advantageous to apply a pressure onto the stack while the stack is being heated to substantially above (e.g., by about 25° C. or more) the operating temperatures after (in some designs during) the electrolyte infiltration. In some designs, the hot-press temperature may be at least about 25° C. lower (in some designs, at least about 50° C. lower) than the electrolyte infiltration temperature.

In some designs, it is advantageous to prevent a relatively hot electrolyte from inducing significant undesirable damage to the separator membrane, to the binder, to the conductive additives, to the active material, to the electrical and mechanical integrity of the electrodes, to the current collectors and to other important components of the individual electrodes (if individual electrodes are infiltrated with a suitable molten electrolyte) or to the electrode/separator stack (or roll) (if a stack or roll is infiltrated with a suitable molten electrolyte) or to the pre-assembled cell (if the stack or roll is pre-assembled/pre-packaged into the case before the infiltration with a suitable electrolyte). Some of the aspects of the present disclosure describe route enhancements to overcome such potential negative effects. It has also been found that many hot electrolyte melts exhibit poor wetting on some conductive carbon additives and some polymer binders. Some of the aspects of the present disclosure describe route enhancements to overcome such potential negative effects.

In some designs, to reduce gas generation and also to enhance mechanical strength of the electrodes at elevated temperatures (including the cell heating and cooling during the electrolyte infiltration), thermally-stable (at near the melt-infiltration temperatures) elongated particles (such as nanowires, whiskers (including various type of ceramic whiskers), nanotubes (including various type of carbon nanotubes), flakes, etc.) with aspect ratios above about 3 (preferably above about 10 and even more preferably above about 30) and the smallest dimensions (e.g., diameter or thickness) below about 400 nm (in some designs, preferably below about 100 nm and, in some designs, even more preferably below about 30 nm) may be added into the electrode (or electrode/binder) mix. In some designs, elongated (in two or preferably in one dimension) nanoparticles may be used to connect/join the active material particles and may enhance the mechanical and electrical stability of the electrodes during the melt infiltration. In some designs, such particles may additionally enhance the electrical conductivity (e.g., if the particles are electrically conductive) and reduce gas generation or accumulation (e.g., if the particles adsorb at least some of the gasses generated, if the particles modify the structure and properties of the binders, if the particles assist in forming interconnected pathways for gasses to escape from the electrode, etc.) during the electrolyte melt-infiltration process. In some designs, a suitable weight fraction of such elongated particles may range from around 0.01 wt. % to around 25 wt. % and from around 0.01 vol. % to around 25 vol. % of the total electrode mass and volume, respectively. It may be useful to select two or more kinds of elongated particles/additives in order to achieve an optimal electrode performance in cells (e.g., combine (1) ceramic (e.g., oxide, nitride, sulfide, fluoride, etc.) particles that may offer enhanced electrolyte wetting or may adsorb some of the gasses or bond particularly well with a binder with (2) conductive (e.g., carbon) particles that may offer enhanced electrical conductivity to the electrode). If two types of particles are used, their relative weight fractions may range from about 1:1000 to about 1000:1.

In some designs, it may be advantageous to induce holes into the electrodes (in some designs, propagating from the electrode surface towards the current collector—partially or all the way or even through the current collector) prior to electrolyte infiltration. In some designs, such holes may greatly enhance the rate of the electrolyte infiltration into the electrode(s) (which may be particularly important with relatively viscous (e.g., >about 1000 cP) (e.g., molten) electrolytes) and additionally mechanically enhance the electrode(s). In some designs, a suitable size (e.g., average diameter in case of cylindrical or pyramid-shaped/cone-shaped holes) may range from around 2.5 micron to around 500 microns (in some designs, from around 10 micron to around 100 micron) and an average spacing between the holes may range from around 100 micron to around 5,000 micron. In some designs, it may be preferable (e.g., in order to mitigate volumetric capacity reduction) for the total volume of the holes to remain below about 10.00 vol. % (in some designs, from around 0.01 vol. % to around 2.00 vol. %) of the total electrode volume. In some designs, such holes may be produced by mechanical mechanisms, by forming bubbles during casting or during drying, by laser micro-machining or by other suitable techniques.

Conventional cells infiltrated with a liquid electrolyte contain no remaining porosity between the active electrode particles. However, in some configurations, solid state cells produced by infiltration of the electrolyte melt may benefit from some of the remaining (inter-particle) porosity because such inter-particle porosity may assist in accommodating some of the stresses occurring during cell fabrication (e.g., thermal stresses) or during cell use (e.g., cell bending). The useful volume fraction of the remaining pores may depend on the cell configuration, electrode thickness, composition and microstructure of the electrode, electrolyte, and separator layers, and in some designs may range from around 0.05 vol. % to around 5 vol. % (as a fraction of the total volume of the electrode). A larger volume fraction may also be used in some designs, although this will reduce energy density and power density of the solid electrolyte cells.

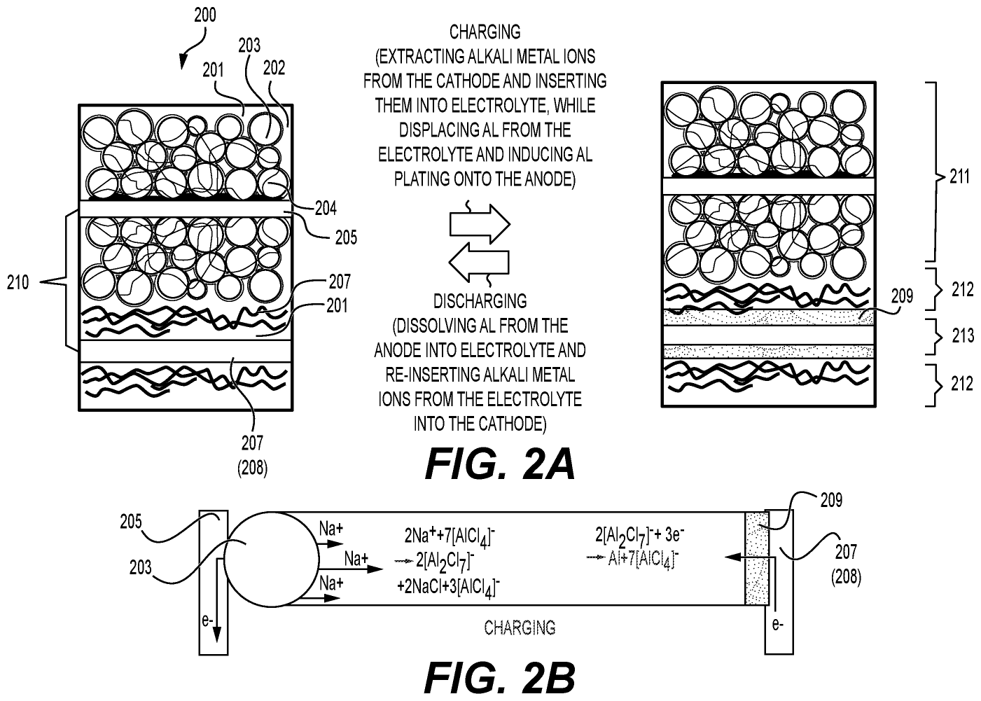

FIG. 2A show illustrative example building block 200 of a disclosed cell of suitable properties comprising a suitable Al-comprising electrolyte 201 of suitable composition, properties and volume fraction, a suitable alkali metal ion cathode active material 203 optionally coated with a suitable protective surface layer 202, a suitable cathode current collector 205 of suitable composition and properties (optionally coated with a suitable protective layer), a suitable porous separator 206 filled with electrolyte 201, a suitable anode current collector 207 (which may also serve as an Al-comprising anode 208). Upon charge, alkali metal ions (e.g., Na⁺) are extracted from the cathode active material and added into electrolyte, while Al is extracted from the electrolyte and plated onto (or alloyed with) the anode current collector 207 or anode 208 forming the deposited Al (or Al alloy) layer 209. A half of the cathode current collector 205, one side of the cathode coating, the separator 206 and half of the anode 208 and anode current collector 207 constitute a battery unit stack 210. Another way to look at the building block 200 is to separate the building block 200 into a cathode portion 211, a separator portion 212, an anode portion 213 and another separator portion 212.

FIG. 2B show illustrative example of processes (e.g., reactions) that may happen (in some designs) on the cathode/electrolyte interfacial region (e.g., extraction of alkali metal ions (e.g., Na⁺) from the cathode and the formation of alkali metal halides (e.g., chlorides)) and on the anode/electrolyte interfacial region (e.g., reduction of some of the Al-comprising anions with the formation of deposited Al metal layer) based on the building block 200 of FIG. 2A. Note that such reactions are provided solely for illustrating the concept and the actual reactions taking place in each of the cathode half-cell and the cathode half-cell may differ.

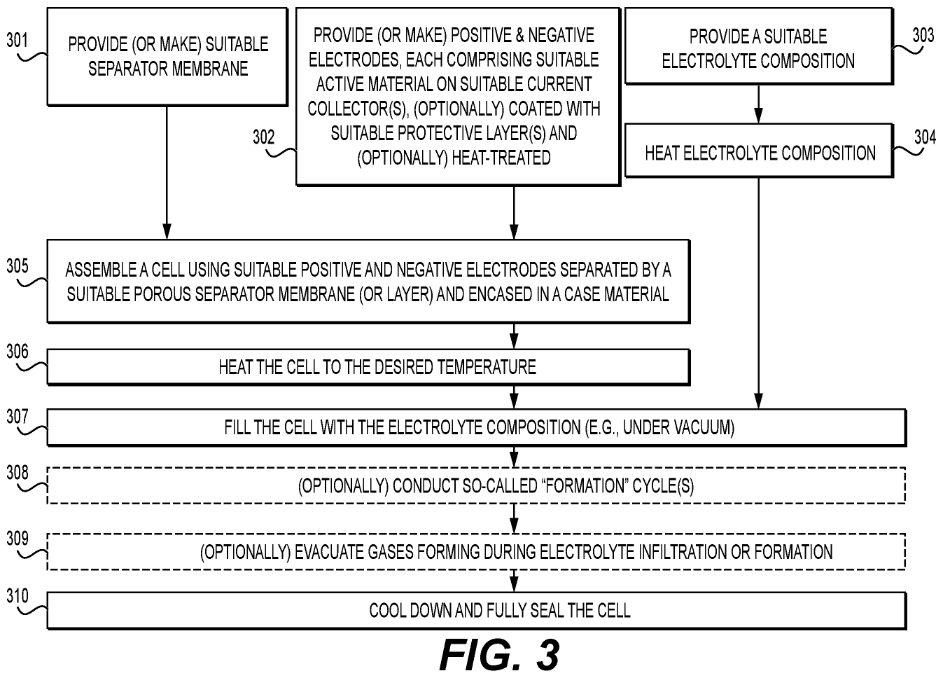

FIG. 3 shows an illustrative example process for the fabrication of the cell produced according to one or more disclosed embodiment(s). Such a process may involve: providing (e.g., procuring, making, modifying, etc.) a suitable separator membrane or a suitable separator membrane material (block 301); providing (e.g., procuring, making, modifying, etc.) a suitable anode and a suitable cathode (block 302); providing (e.g., procuring, making, modifying, etc.) a suitable electrolyte (e.g., solid electrolyte) composition (block 303); heating electrolyte composition to a desired and suitable temperature (block 304); assembling a cell using the anodes and cathode separated by a porous separator membrane or a separator layer (block 305); heating the cell to the desired and suitable temperature (block 306); filling the heated cell with the heated electrolyte (block 307) (e.g., here, heated electrolyte may refer to melt-infiltration of solid electrolyte or liquid electrolyte that is capable of withstanding elevated temperatures); optionally conducting charge or charge-discharge (“formation”) cycle(s) (block 308); optionally evacuating gasses that may form (block 309); cooling down and sealing the cell (block 310).

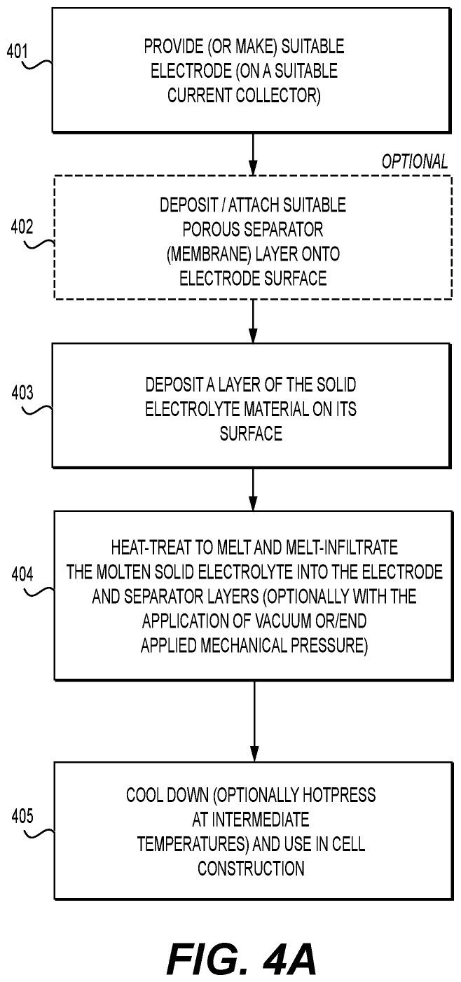

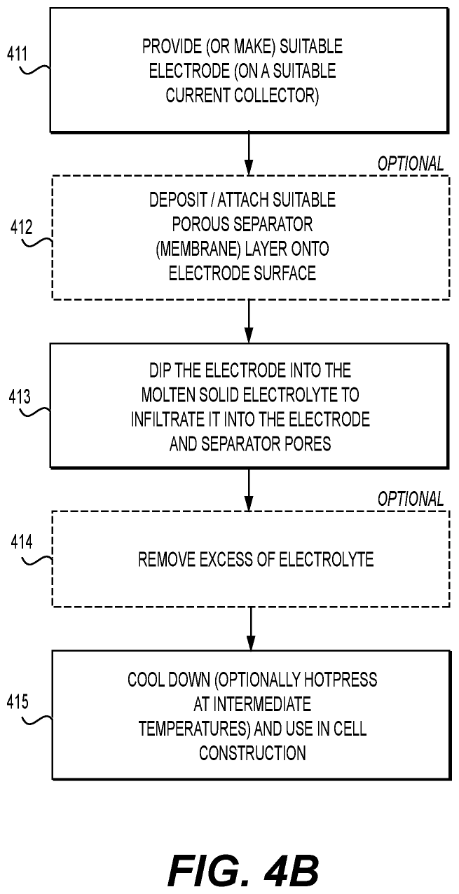

FIGS. 4A-4B show example processes for manufacturing electrodes infiltrated with electrolytes of the type disclosed herein. The process of FIG. 4A may involve: providing (e.g., procuring, making, modifying, etc.) a suitable electrode (block 401); (optionally) depositing or attaching a suitable separator membrane onto the electrode surface (optional block 402); depositing a layer of the solid electrolyte on the top surface of the electrode (e.g., in the form of a powder or a paste) (block 403); heating the assembly (to melt electrolyte) and melt-infiltrating the electrode (with optional separator layer) with the molten electrolyte (block 404); and cooling down to room temperature for use in the desired cell construction (block 405). The process of FIG. 4B may involve: providing (e.g., procuring, making, modifying, etc.) a suitable electrode (block 411); (optionally) depositing or attaching a suitable separator membrane onto the electrode surface (optional block 412); dipping the assembly into the molten electrolyte and melt-infiltrating the electrolyte into the pores (block 413); (optionally) removing excess of electrolyte (optional block 414); and cooling down to room temperature for use in the desired cell construction (block 415).

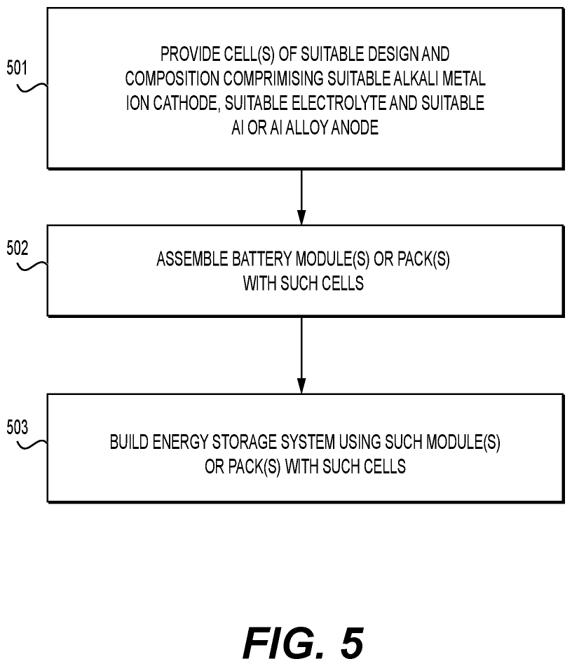

FIG. 5. shows an example process for the fabrication of novel energy storage systems according to embodiments of the present disclosure. The process of FIG. 5 may involve: providing (e.g., procuring, making, modifying, etc.) suitable cells comprising suitable alkali metal ion cathode, suitable electrolyte and suitable Al or Al alloy anode (block 501); assembling suitable cells into battery modules or battery packs (block 502); building energy storage system using such module(s) or pack(s) with such cells (block 503).

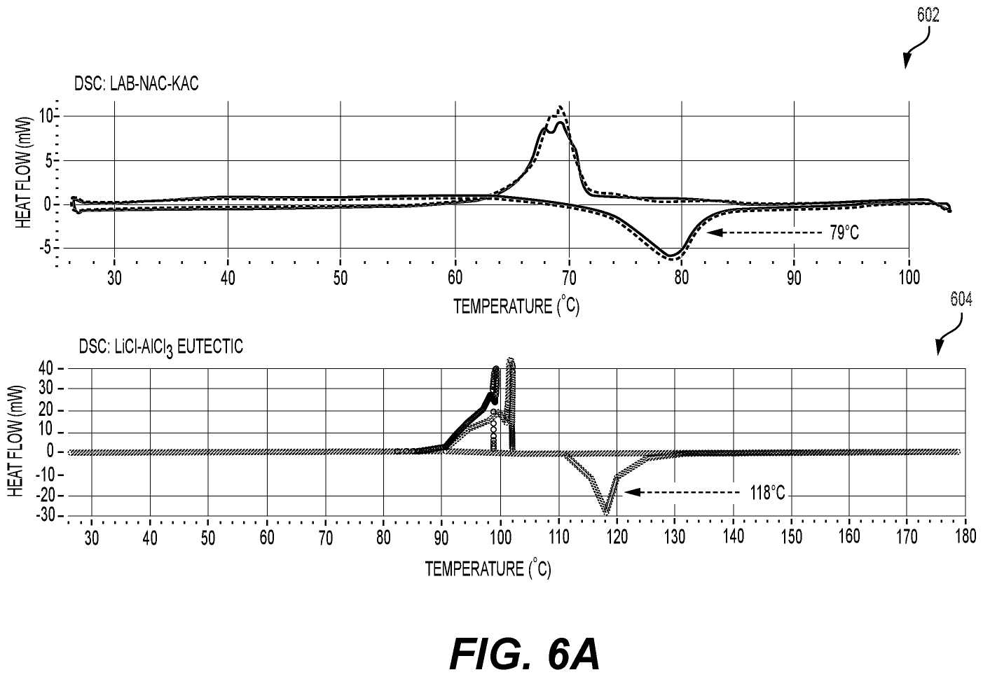

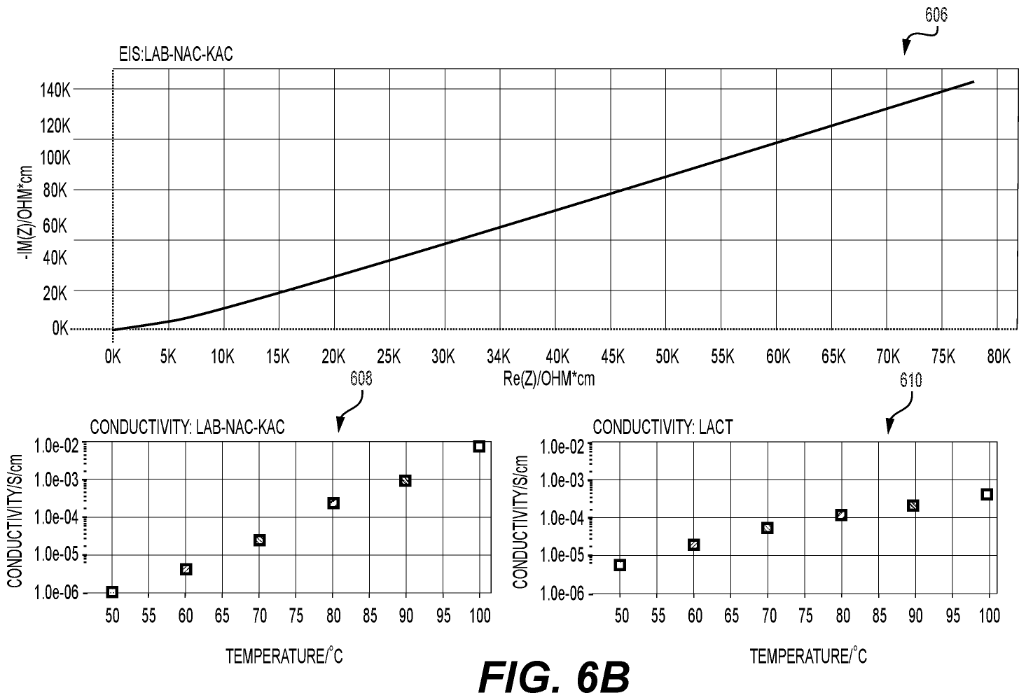

FIG. 6A illustrates differential scanning calorimetry (DSC) measurements using a DSC Q2000 (TA Instruments) for two example electrolyte compositions produced in accordance with an embodiment of the disclosure. In the DSC examples, the heating and cooling rates were set to 10° C./min. In these illustrative examples the electrolyte compositions were selected to be: (top graph, 602) low temperature eutectic mixture of lithium aluminum bromide (LiAlBr₄, abbreviated as LAB) with sodium aluminum chloride (NaAlCl₄, abbreviated as NAC) and with potassium aluminum chloride (KAlCl₄, abbreviated as KAC) in a 0.3:0.5:0.2 molar ratio (herein, LAB-NAC-KAC is the nomenclature abbreviation used for 0.3:0.5:0.2 molar ratio); (bottom graph, 604) LiCl-AlCl₃ eutectic mixture in 0.42:0.58 molar ratio. Low phase transition (melting and solidification) temperatures (e.g., melting temperature of about 79° C. for LAB-NAC-KAC sample and melting temperature of about 118° C. for LiCl—AlCl₃ sample) are clearly seen from the DSC measurements for both electrolyte examples.

FIG. 6B (top graph, 606) illustrates a Nyquist plot example obtained from electrochemical impedance spectroscopy (EIS) measurements of LAB-NAC-KAC (0.3:0.5:0.2 molar ratio) at 100° C., (bottom) as well as the corresponding temperature dependence for the conductivity value extracted from EIS measurements for (bottom left graph, 608) LAB-NAC-KAC and (bottom right graph, 610) an eutectic mixture containing a mixture of LiAlCl₄ (abbreviated as LAC) with AlCl₃—LiTFSI (LACT) adduct in a 0.63:0.37 molar ratio. The cell stacks measured by EIS were prepared by in-situ melt-infiltration of the electrolytes into a stack composed of symmetric 18 mm diameter stainless steel current collectors and a 260 μm thick glass fiber separator. The EIS measurements were taken using a Biologic VMP-3 potentiostat, a frequency range of 1 MHz-50 MHz, and a current amplitude of 4 μA or voltage amplitude 10 mV. The mass loading of the example electrolyte compositions was ˜150-200 mg.

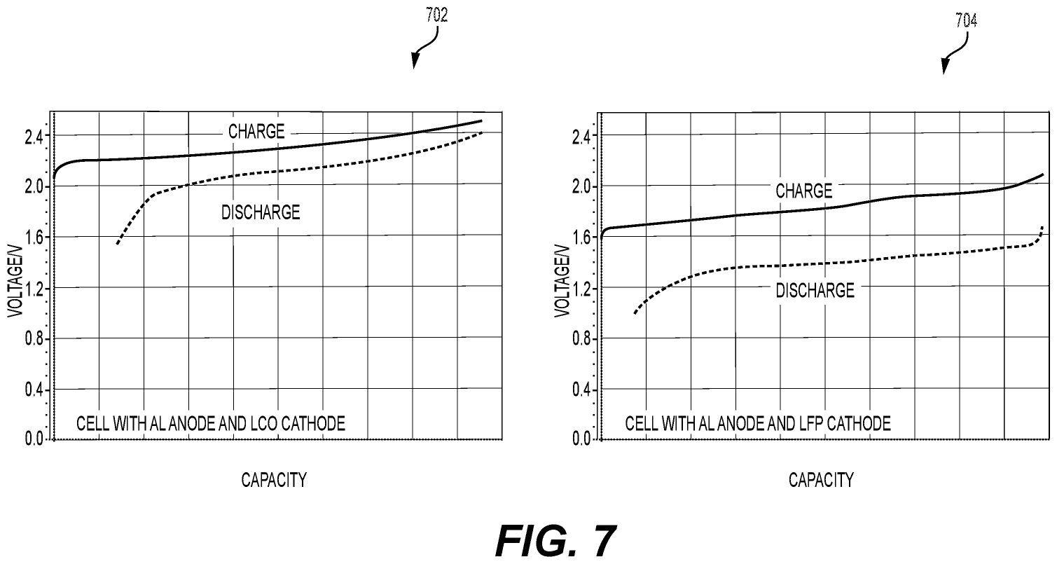

FIG. 7 illustrates two example charge-discharge profiles for two example battery cells produced in accordance with an embodiment of the disclosure. The illustrated battery cells comprised Al foil anode and two different cathodes—(left graph, 702) a layered metal oxide (lithium cobalt oxide in this example) and (right graph, 704) an olivine metal phosphate (lithium iron phosphate in this example). In the examples shown, the electrolyte used was an LAC-AlCl₃—LiTFSI (0.75:0.125:0125 molar ratio) solid electrolyte. Other intercalation-type or conversion-type cathode materials may be used in suitable designs. The charge-discharge measurements were taken using a Biologic VMP-3 potentiostat at a rate of ˜(about) C/10. The lithium cobalt oxide (LCO) cathode was prepared by coating a stainless-steel current collector foil with a slurry (containing 59.32 wt. % solids) with a composition of 0.59 wt. % carbon black, 1.58 wt. % polyvinylidene fluoride (PVDF), and 57.15 wt. % LCO, with the remaining 40.68% of the slurry being N-methyl-2-pyrrolidone (NMP) solvent. The lithium iron phosphate (LFP) cathode was prepared by coating a stainless-steel current collector foil with a slurry (containing 39.31 wt. % solids) with a composition of 0.83 wt. % polyamide-imide (PAI), 0.83 wt. % PVDF, 1.15 wt. % carbon black, and 36.5 wt. % LFP, with the remaining 60.69 wt. % of the slurry being NMP solvent. The areal-capacity loading for both LCO and LFP cathodes was ˜1 mAh/cm². In the illustrated examples an alumina nanofiber separator was utilized in accordance with an embodiment of the disclosure. Other separators such as glass fiber separators may be used in suitable designs.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A rechargeable battery cell, comprising: an anode; a cathode; a separator layer electrically separating the anode and the cathode; and an electrolyte ionically coupling the anode and the cathode; wherein: the anode comprises aluminum (Al) metal or an Al alloy; the cathode comprises a cathode active material comprising at least one alkali metal; the electrolyte comprises Al and ions of the at least one alkali metal; the Al in the electrolyte alloys with or plates on the anode and the alkali metal de-insert from the cathode into the electrolyte during charging of the rechargeable battery cell; and the Al de-alloys or de-plates from the anode into the electrolyte and the alkali metal ions insert from the electrolyte into the cathode during discharging of the rechargeable battery cell.

Clause 2. The rechargeable battery cell of clause 1, wherein the at least one alkali metal comprises sodium (Na) or potassium (K) or both.

Clause 3. The rechargeable battery cell of any of clauses 1 to 2, wherein the at least one alkali metal comprises the Na and an atomic fraction of the Na in all the alkali metal is about 50 at. % or more.

Clause 4. The rechargeable battery cell of any of clauses 1 to 3, wherein the at least one alkali metal comprises the K and an atomic fraction of the K in all the alkali metal is about 50 at. % or more.

Clause 5. The rechargeable battery cell of any of clauses 1 to 4, wherein a weight fraction of lithium (Li) in all the alkali metal is less than about 5 wt. %.

Clause 6. The rechargeable battery cell of any of clauses 1 to 5, wherein the electrolyte comprises a halide salt comprising Al, a nitrate salt comprising Al, and/or an imide salt comprising an alkali metal.

Clause 7. The rechargeable battery cell of any of clauses 1 to 6, wherein the electrolyte exhibits a melting point in a range of about 40° C. to about 300° C.

Clause 8. The rechargeable battery cell of clause 7, wherein the melting point is in a range of about 60° C. to about 220° C.

Clause 9. The rechargeable battery cell of any of clauses 1 to 8, wherein the electrolyte comprises an ionic liquid.

Clause 10. The rechargeable battery cell of any of clauses 1 to 9, wherein the electrolyte comprises a solvent composition, a boiling point of the solvent composition being at least about 120° C.

Clause 11. The rechargeable battery cell of any of clauses 1 to 10, wherein the electrolyte comprises a solvent composition, a weight fraction of the solvent composition in the electrolyte being about 10 wt. % or less.

Clause 12. The rechargeable battery cell of any of clauses 1 to 11, wherein the electrolyte is fully or partially solid during at least a portion of the charging and/or discharging of the rechargeable battery cell.

Clause 13. The rechargeable battery cell of any of clauses 1 to 12, wherein the separator membrane comprises elongated particles with an average aspect ratio of about 30 or greater.

Clause 14. The rechargeable battery cell of any of clauses 1 to 13, wherein the separator membrane comprises ceramic particles.

Clause 15. The rechargeable battery cell of any of clauses 1 to 14, wherein the cathode active material comprises a layered metal oxide or an olivine metal phosphate or Prussian Blue/Prussian White analogs.

Clause 16. The rechargeable battery cell of any of clauses 1 to 15, wherein: a concentration of the Al in the electrolyte increases during the discharging; a concentration of the alkali metal ions in the electrolyte decreases during the discharging; the concentration of the Al in the electrolyte decreases during the charging; and the concentration of the alkali metal ions in the electrolyte increases during the charging.

Clause 17. An energy storage system, comprising: a plurality of instantiations of the rechargeable battery cell of any of clauses 1 to 16.

Clause 18. A method of making a rechargeable battery cell, the method comprising: (A1) providing an anode comprising aluminum (Al) metal or an Al alloy; (A2) providing a cathode comprising a cathode active material comprising at least one alkali metal; (A3) melt-infiltrating an electrolyte into (a) the anode, or (b) the cathode, or (c) the anode and the cathode; and (A4) assembling the rechargeable battery cell comprising the anode and the cathode, wherein: the electrolyte ionically couples the anode and the cathode in the rechargeable battery cell; and the electrolyte comprises Al and ions of the at least one alkali metal.

Clause 19. The method of clause 18, wherein the electrolyte exhibits a melting point in a range of about 40° C. to about 300° C.

Clause 20. The method of any of clauses 18 to 19, wherein: the method further comprises providing a separator layer on at least one of the anode and the cathode.

The description is provided to enable any person skilled in the art to make or use embodiments of the present disclosure. It will be appreciated, however, that the present disclosure is not limited to the particular formulations, process steps, and materials disclosed herein, as various modifications to these embodiments will be readily apparent to those skilled in the art. That is, the generic principles defined herein may be applied to other embodiments without departing from the spirit or scope of the disclosure.

1. A rechargeable battery cell, comprising:
an anode;
a cathode;
a separator layer electrically separating the anode and the cathode; and
an electrolyte ionically coupling the anode and the cathode;
wherein:
the anode comprises aluminum (Al) metal or an Al alloy;
the cathode comprises a cathode active material comprising at least one alkali metal;
the electrolyte comprises Al and ions of the at least one alkali metal;
the Al in the electrolyte alloys with or plates on the anode and the alkali metal de-insert from the cathode into the electrolyte during charging of the rechargeable battery cell; and
the Al de-alloys or de-plates from the anode into the electrolyte and the alkali metal ions insert from the electrolyte into the cathode during discharging of the rechargeable battery cell.

2. The rechargeable battery cell of claim 1, wherein the at least one alkali metal comprises sodium (Na) or potassium (K) or both.

3. The rechargeable battery cell of claim 1, wherein the at least one alkali metal comprises the Na and an atomic fraction of the Na in all the alkali metal is about 50 at. % or more.

4. The rechargeable battery cell of claim 1, wherein the at least one alkali metal comprises the K and an atomic fraction of the K in all the alkali metal is about 50 at. % or more.

5. The rechargeable battery cell of claim 1, wherein a weight fraction of lithium (Li) in all the alkali metal is less than about 5 wt. %.

6. The rechargeable battery cell of claim 1, wherein the electrolyte comprises a halide salt comprising Al, a nitrate salt comprising Al, and/or an imide salt comprising an alkali metal.

7. The rechargeable battery cell of claim 1, wherein the electrolyte exhibits a melting point in a range of about 40° C. to about 300° C.

8. The rechargeable battery cell of claim 7, wherein the melting point is in a range of about 60° C. to about 220° C.

9. The rechargeable battery cell of claim 1, wherein the electrolyte comprises an ionic liquid.

10. The rechargeable battery cell of claim 1, wherein the electrolyte comprises a solvent composition, a boiling point of the solvent composition being at least about 120° C.

11. The rechargeable battery cell of claim 1, wherein the electrolyte comprises a solvent composition, a weight fraction of the solvent composition in the electrolyte being about 10 wt. % or less.

12. The rechargeable battery cell of claim 1, wherein the electrolyte is fully or partially solid during at least a portion of the charging and/or discharging of the rechargeable battery cell.

13. The rechargeable battery cell of claim 1, wherein the separator membrane comprises elongated particles with an average aspect ratio of about 30 or greater.

14. The rechargeable battery cell of claim 1, wherein the separator membrane comprises ceramic particles.

15. The rechargeable battery cell of claim 1, wherein the cathode active material comprises a layered metal oxide or an olivine metal phosphate or Prussian Blue/Prussian White analogs.

16. The rechargeable battery cell of claim 1, wherein:
a concentration of the Al in the electrolyte increases during the discharging;
a concentration of the alkali metal ions in the electrolyte decreases during the discharging;
the concentration of the Al in the electrolyte decreases during the charging; and
the concentration of the alkali metal ions in the electrolyte increases during the charging.

17. An energy storage system, comprising:
a plurality of instantiations of the rechargeable battery cell of claim 1.

18. A method of making a rechargeable battery cell, the method comprising:
(A1) providing an anode comprising aluminum (Al) metal or an Al alloy;
(A2) providing a cathode comprising a cathode active material comprising at least one alkali metal;
(A3) melt-infiltrating an electrolyte into (a) the anode, or (b) the cathode, or (c) the anode and the cathode; and
(A4) assembling the rechargeable battery cell comprising the anode and the cathode,
wherein:
the electrolyte ionically couples the anode and the cathode in the rechargeable battery cell; and
the electrolyte comprises Al and ions of the at least one alkali metal.

19. The method of claim 18, wherein the electrolyte exhibits a melting point in a range of about 40° C. to about 300° C.

20. The method of claim 18, wherein:
the method further comprises providing a separator layer on at least one of the anode and the cathode.
